(19) United States
(12) Patent Application Publication
(10) Pub. No.: US 2011/0211134 A1
(43) Pub. Date: Sep. 1, 2011

(54) LIGHTING DEVICE, DISPLAY DEVICE AND TELEVISION RECEIVER

(75) Inventor: Takahiro Yoshikawa, Osaka-shi (JP)

(73) Assignee: SHARP KABUSHIKI KAISHA, Osaka-shi, Osaka (JP)

(21) Appl. No.: 13/127,070

(22) PCT Filed: Sep. 7, 2009
(86) PCT No.: PCT/JP2009/065568

§ 371 Date: May 2, 2011

(30) Foreign Application Priority Data
Nov. 27, 2008 (JP) 2008-302695

(51) Int. Cl. H04N 5/66; F21V 7/22; G02F 1/13357

(52) U.S. Cl. 348/739; 362/611; 362/606; 362/612; 349/62; 348/E05.133

(57) ABSTRACT

A backlight unit 12 includes an LED 16, a light guide plate 18, an LED board 17 and a clip 23. The light guide plate 18 includes a light entrance surface 34 and a light exit surface 36. The light entrance surface 34 is provided to face the LED 16 and rays of light emitted from the LED 16 enter the light entrance surface 34. The light exit surface 36 is provided parallel to an arrangement direction in which the LED 16 and the light entrance surface 34 are arranged and rays of light exit through the light exit surface 36. The LED 16 and the light guide plate 18 are fixed to the LED board 17. The light guide plate 18 is fixed to the LED board 17 by the clip 23 and the clip is provided in adjacent to the light entrance surface 34 in the arrangement direction in which the LED 16 and the light entrance surface 34 are arranged.

### TECHNICAL FIELD

The present invention relates to a lighting device, a display device and a television receiver.

### BACKGROUND ART

In recent years, displays of image display devices including television receivers are shifting from conventional cathode-ray tube displays to thin-screen displays including liquid crystal panels and plasma display panels. With the thin-screen displays, thin image display devices can be provided. A liquid crystal display device requires a backlight unit as a separate lighting device because a liquid crystal panel used therein is not a light-emitting component.

For example, a liquid crystal display device reducing its thickness and increasing its size disclosed in Patent Document 1 has been known. The liquid crystal display device includes LEDs and light guide plates. Each of the LEDs has a light emitting surface that emits rays of light in a direction substantially parallel to the display surface of the liquid crystal panel. Each of the light guide plates has a light entrance surface in its side-edge area and a light exit surface on its upper surface.

The light entrance surface faces the LED and rays of light emitting from the LED strike the light entrance surface. The rays of light exit through the light exit surface toward the display surface of the liquid crystal panel. A scattering pattern for scattering the rays of light and a reflection sheet for reflecting the rays of light are formed on a lower surface of the light guide plate, that is a surface opposite from the light exit surface. The scattering pattern and the reflection sheet achieve uniform in-plane brightness distribution on the light exit surface.

Patent Document 1: Japanese Published Patent Application No. 9-90361

Problem to be Solved by the Invention

In the above-mentioned backlight unit, if the LED is turned on and off, temperature environment in the backlight unit changes and this may cause thermal expansion or thermal contraction in the light guide plate. If thermal expansion or thermal contraction is caused in the light guide member, a size of a gap between the light source and the light entrance surface may be altered. This may change entrance efficiency of rays of light emitted from the LED and entering the light guide plate and uneven brightness may be caused in the light guide plate. Especially, if the gap between the light emitting surface of the LED and the light entrance surface of the light guide member increases, the amount of rays of light reflected by the light entrance surface increases and this may lower the light entrance efficiency with respect to the light guide member and deteriorate brightness.

### DISCLOSURE OF THE PRESENT INVENTION

The present invention was made in view of the foregoing circumstances. An object of the present invention is to achieve stable brightness in a lighting device. Another object of the present invention is to provide a display device having the lighting device having stable brightness and a television receiver having such a display device.

Means for Solving the Problem

A lighting device of the present invention includes a light source, light guide member, a base member and a fixing member. The light guide member includes a light entrance surface and a light exit surface. The light entrance surface is provided to face the light source and light emitted from the light source enters the light entrance surface. The light exit surface is provided parallel to an arrangement direction in which the light source and the light entrance surface are arranged. The light exits through the light exit surface. The light source and the light guide member are fixed to the base member. The fixing member is configured to fix the light guide member to the base member and provided in adjacent to the light entrance surface in the arrangement direction in which the light source and the light entrance surface are arranged.

Turning on and off of the light source changes the temperature environment in the lighting device and this causes thermal expansion or thermal contraction in the light guide member. In such a case, the thermal expansion or the thermal contraction is originated from the fixing point of the light guide member to the base member by the fixing member. The fixing member is provided in adjacent to the light entrance surface with respect to the arrangement direction in which the light source and the light entrance surface are arranged. Therefore, even if thermal expansion or thermal contraction occurs in the light guide member, change in the relative positions of the light source and the light entrance surface with respect to the arrangement direction is less likely to occur. Therefore, the entrance efficiency of light emitted from the light source and entering the light guide member is stabilized.

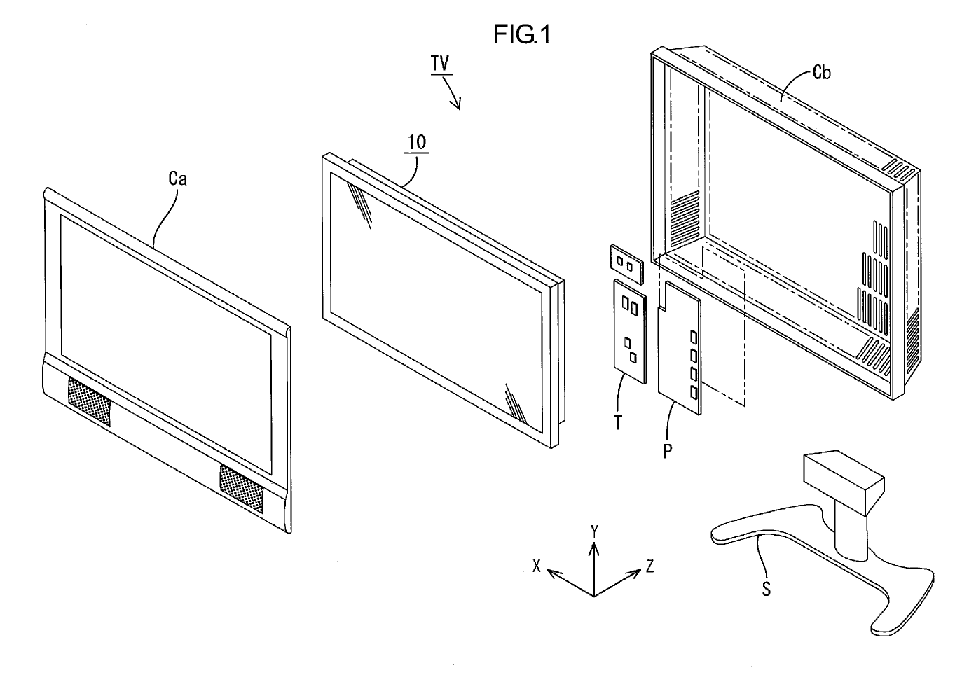

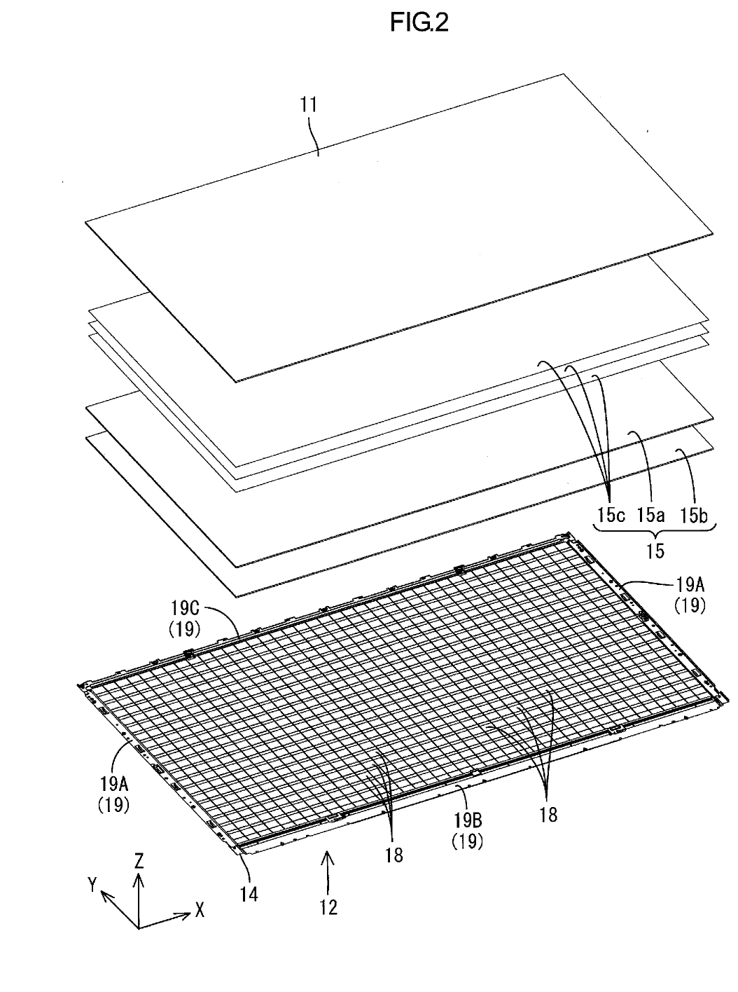

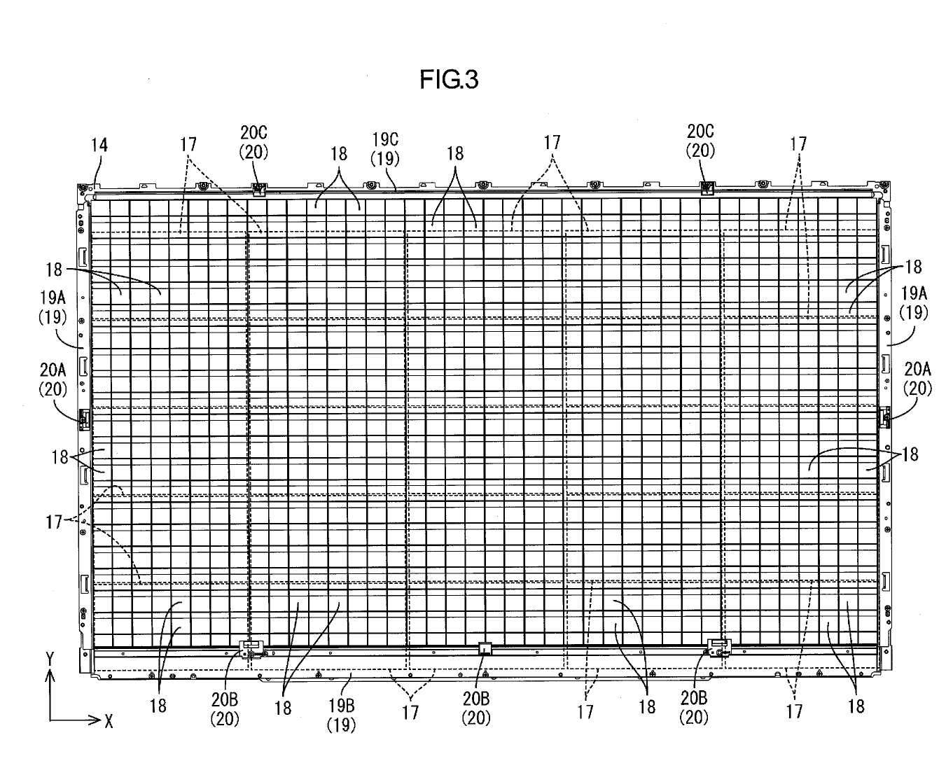

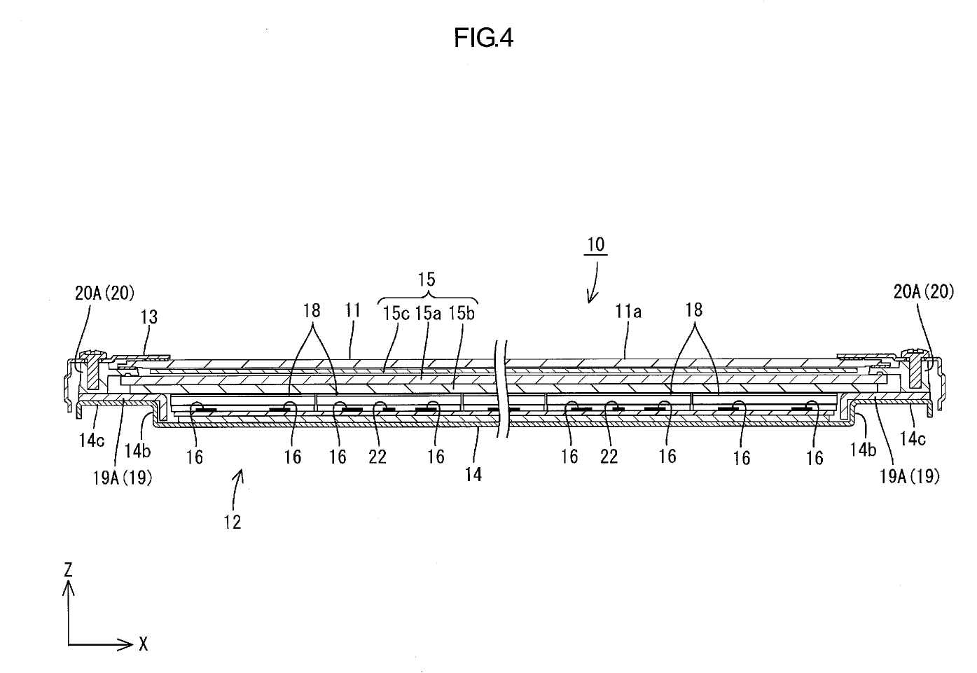

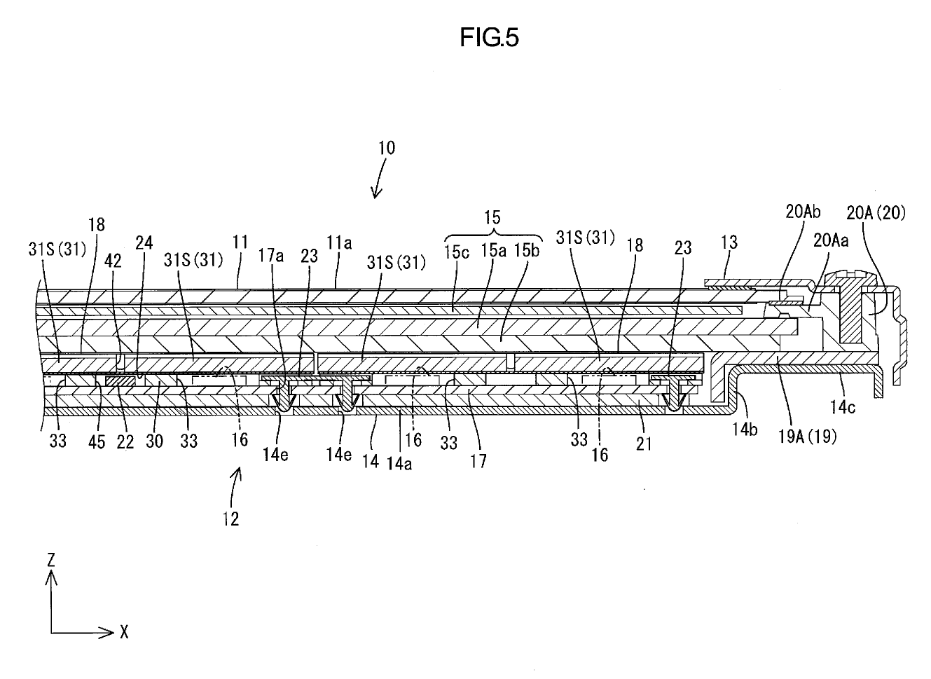

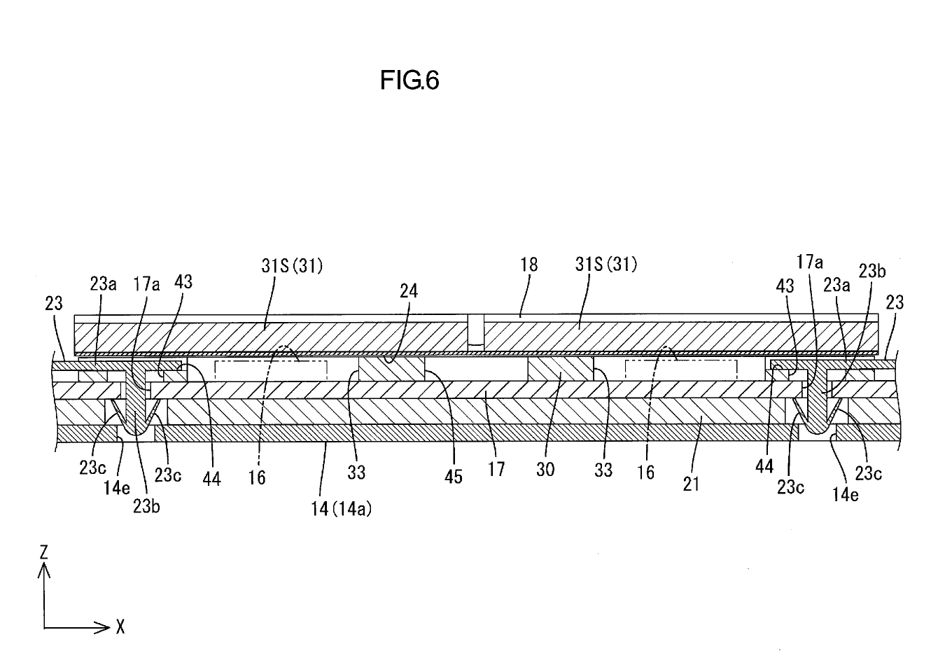

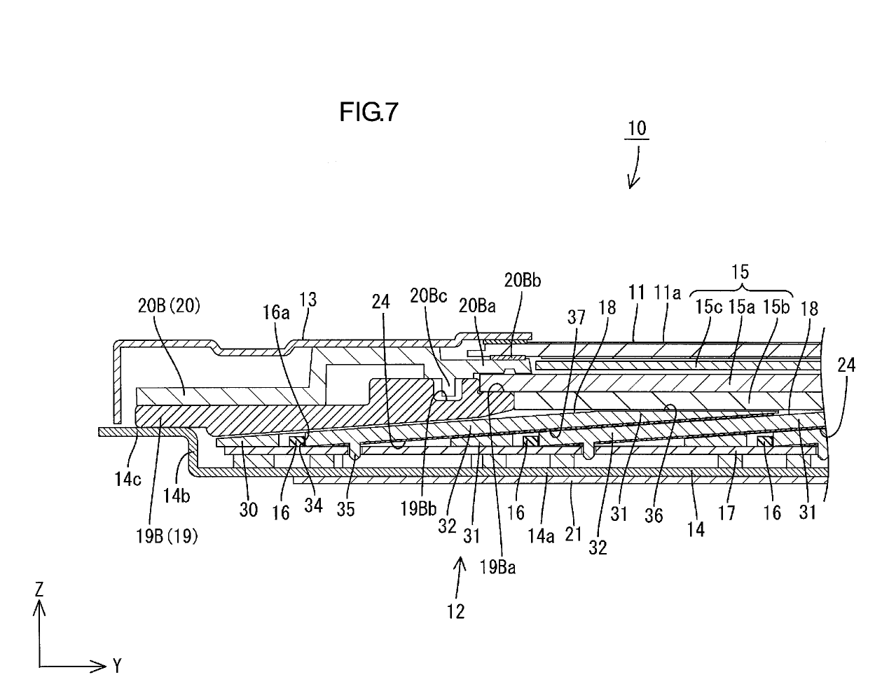

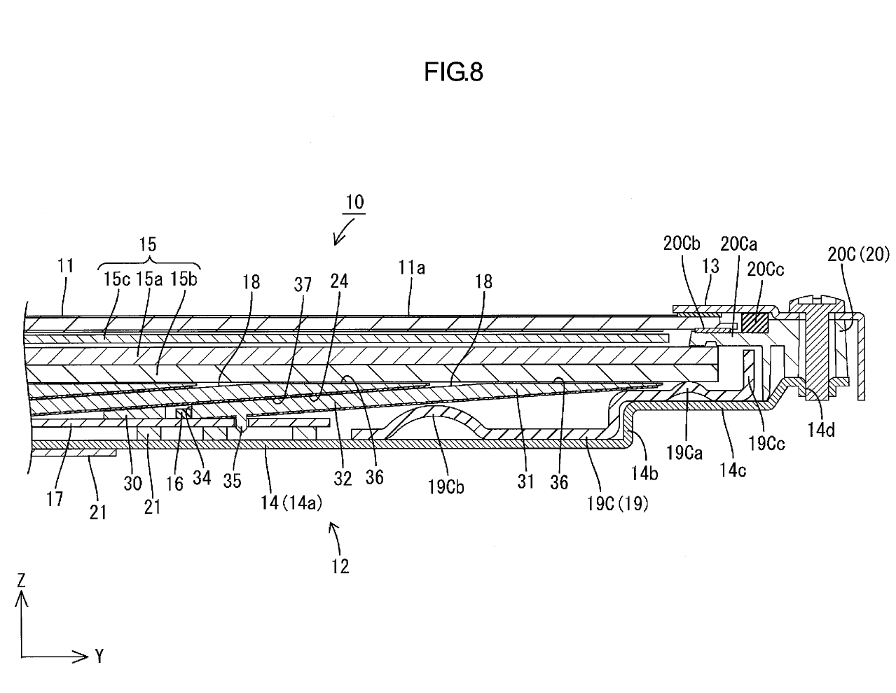

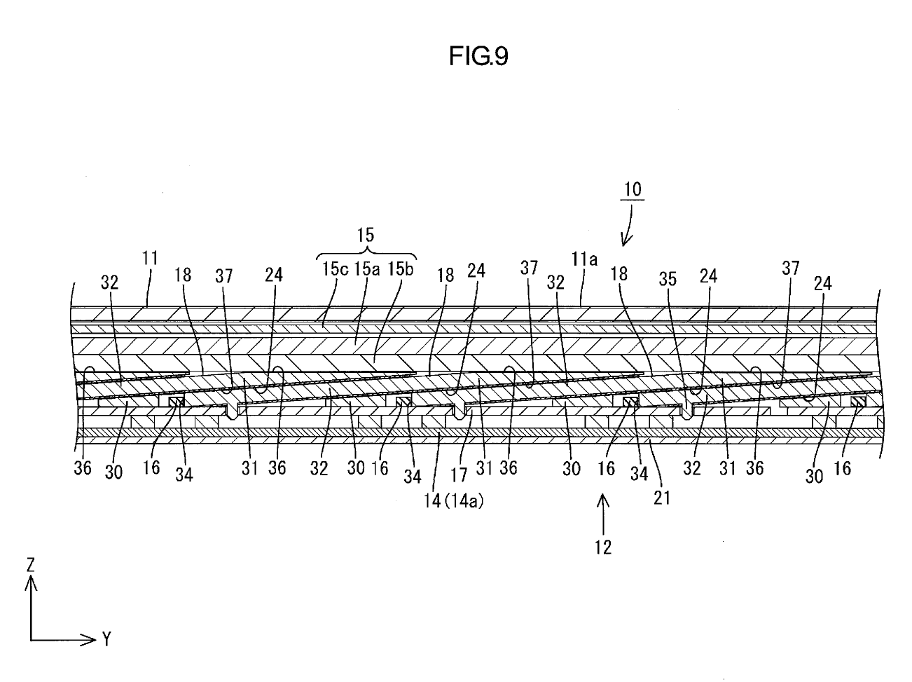

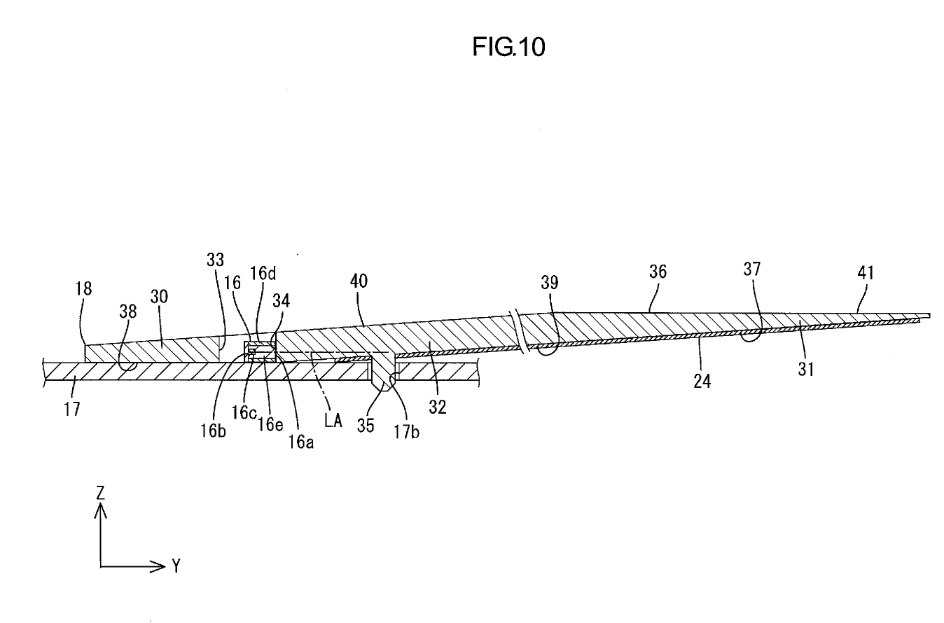

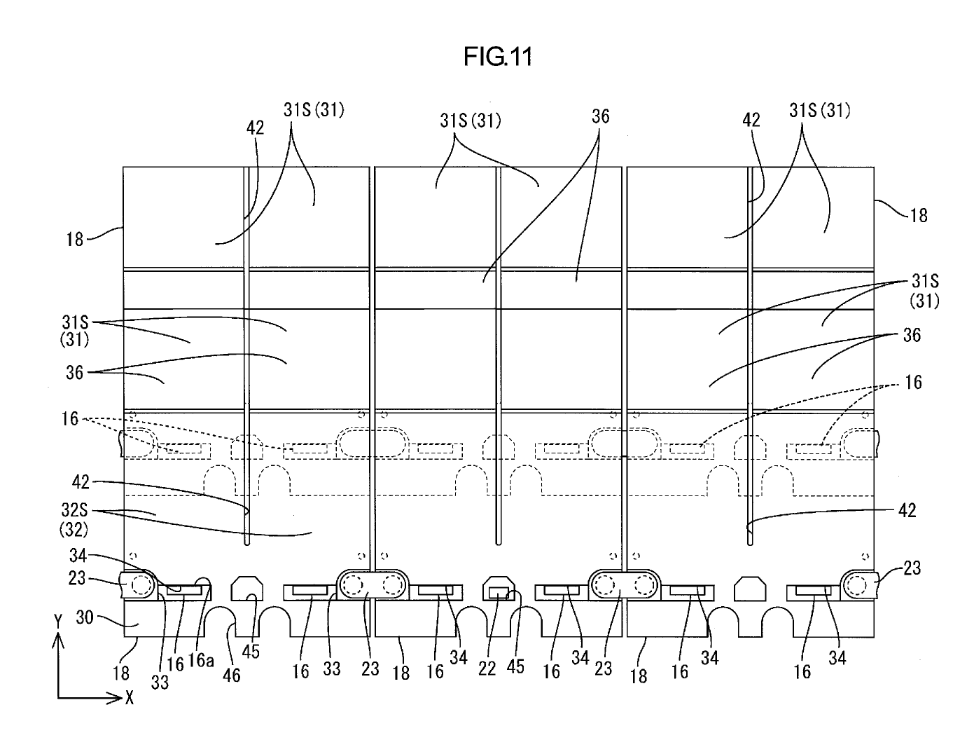

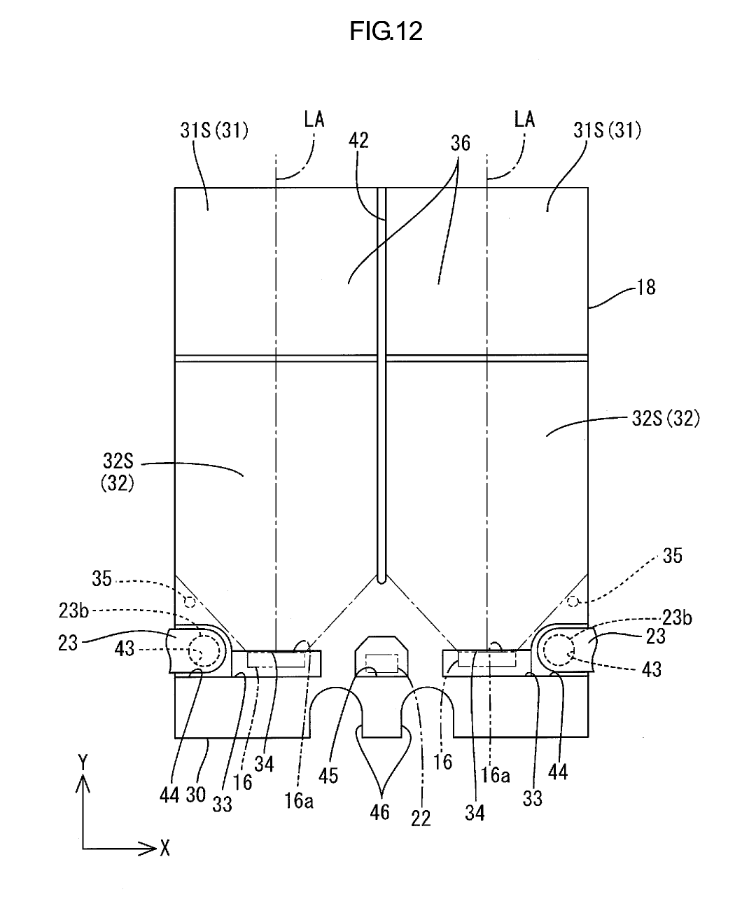

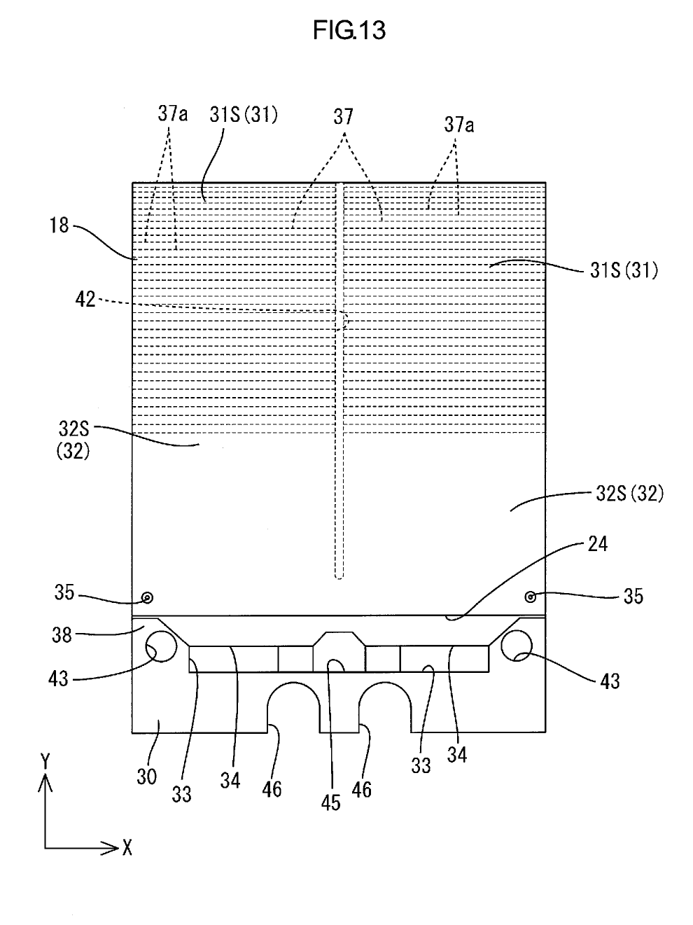

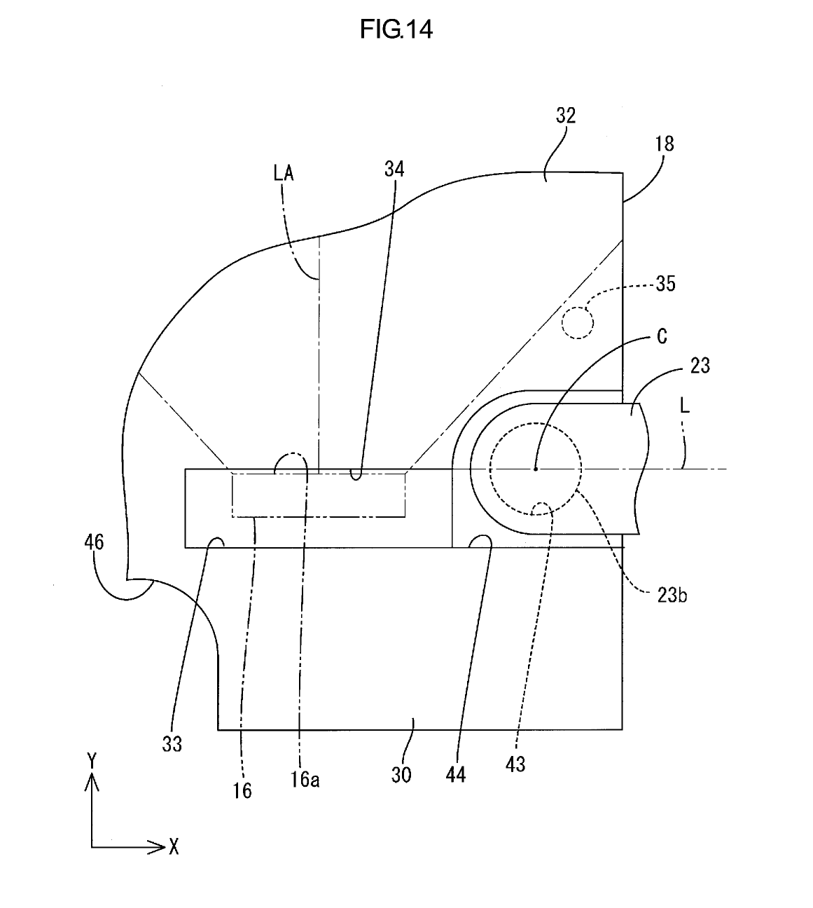

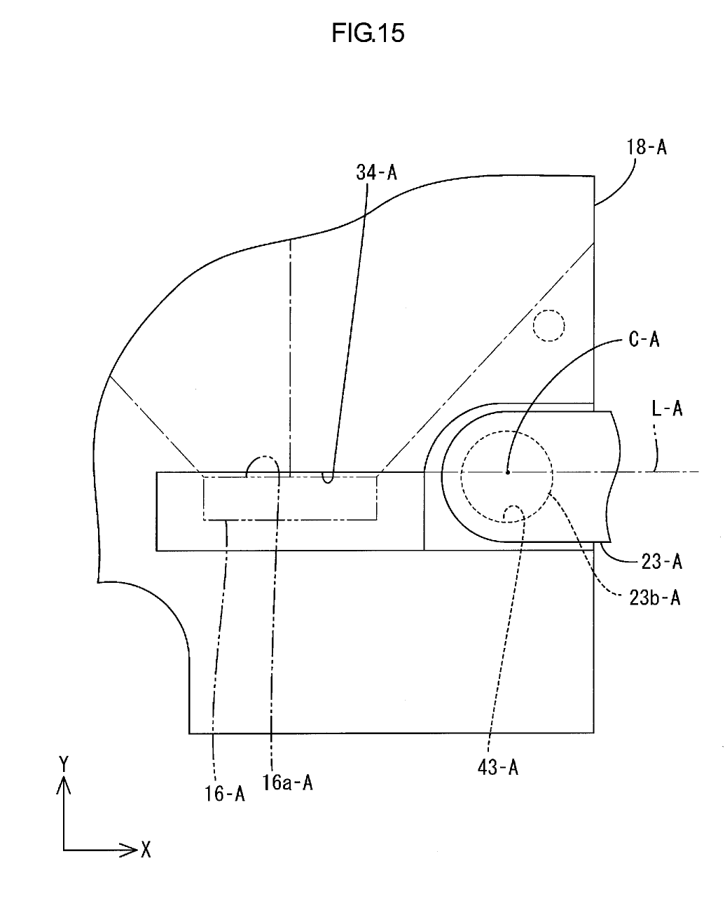

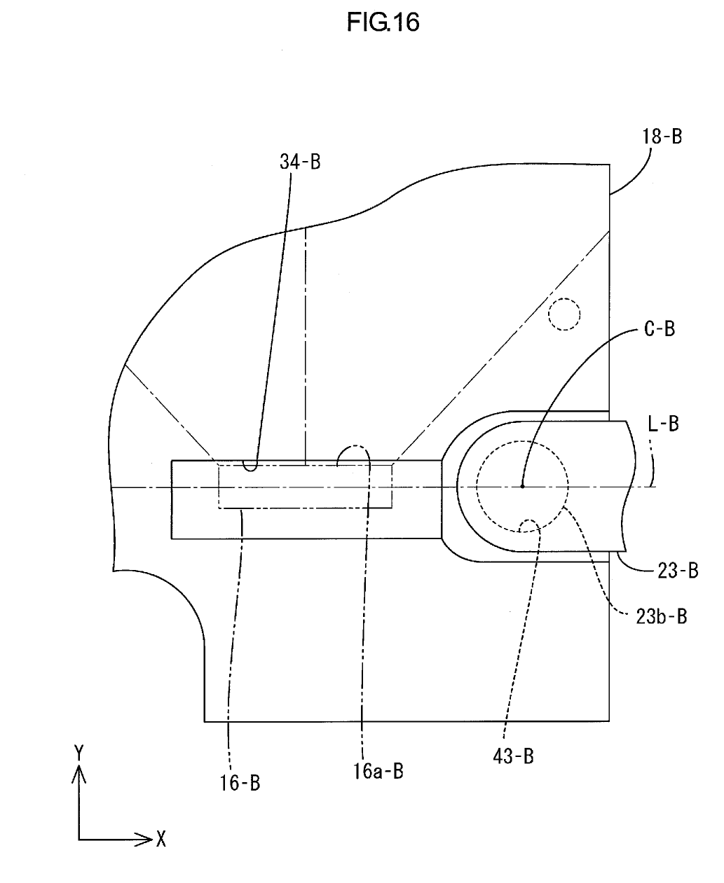

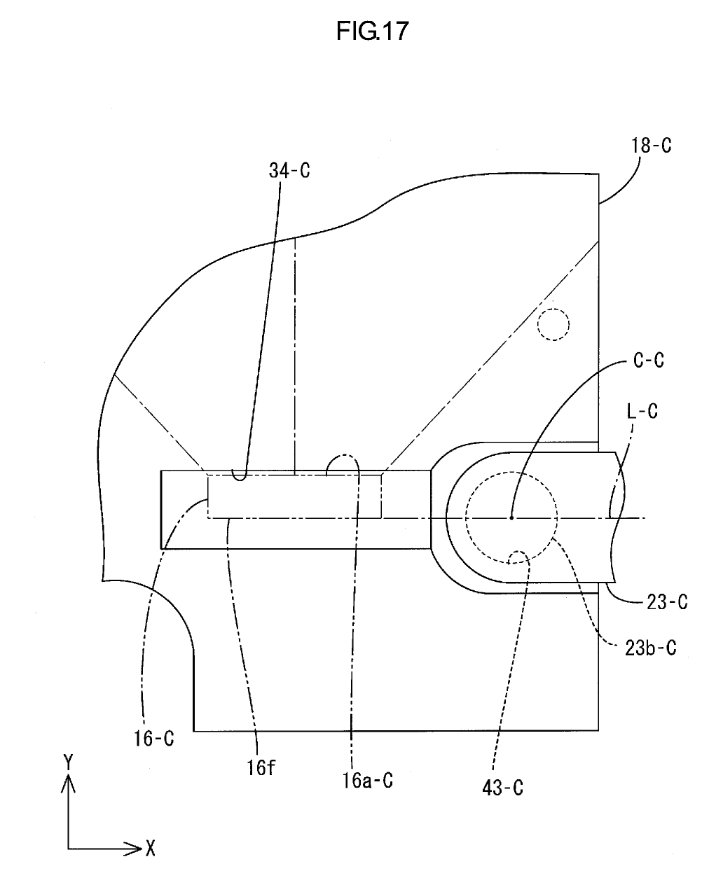

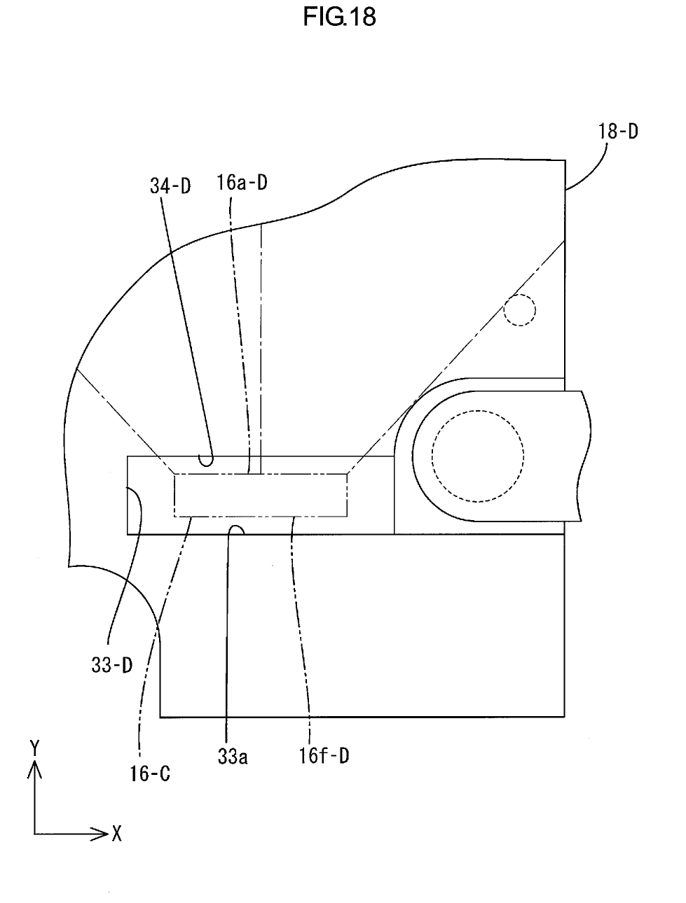

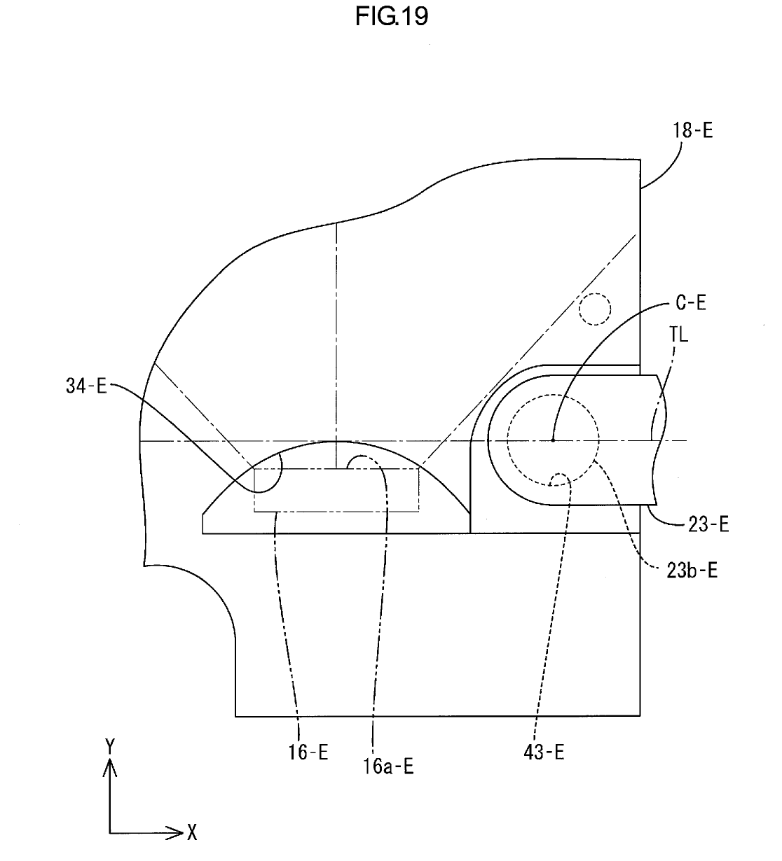

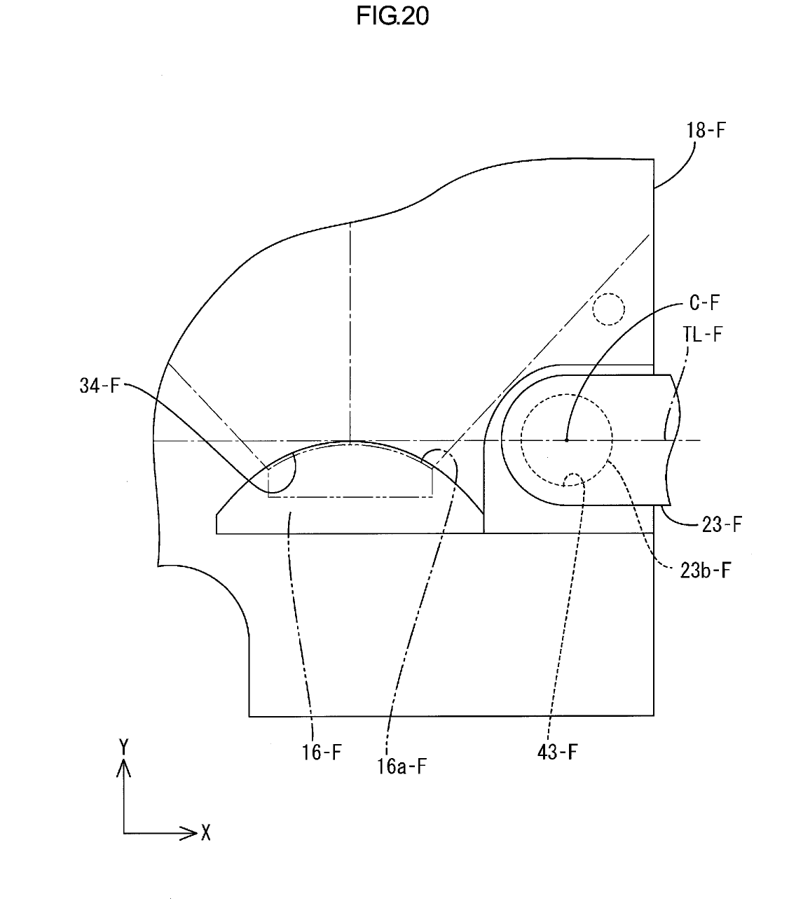

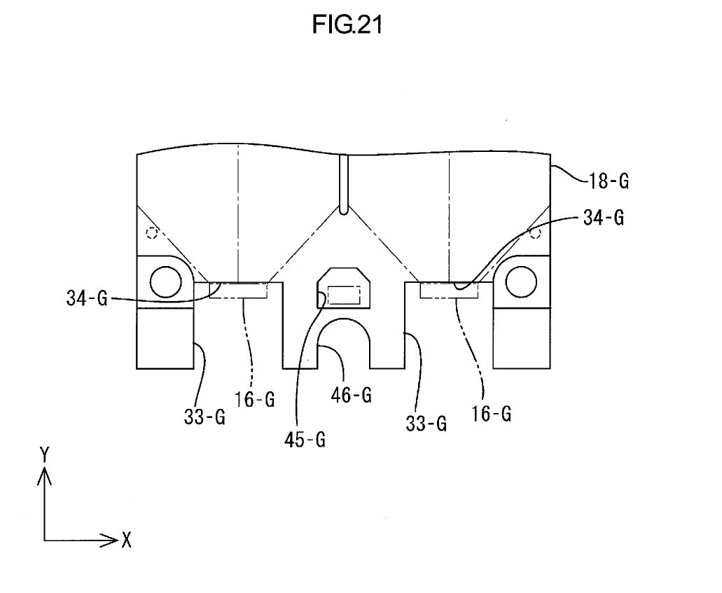

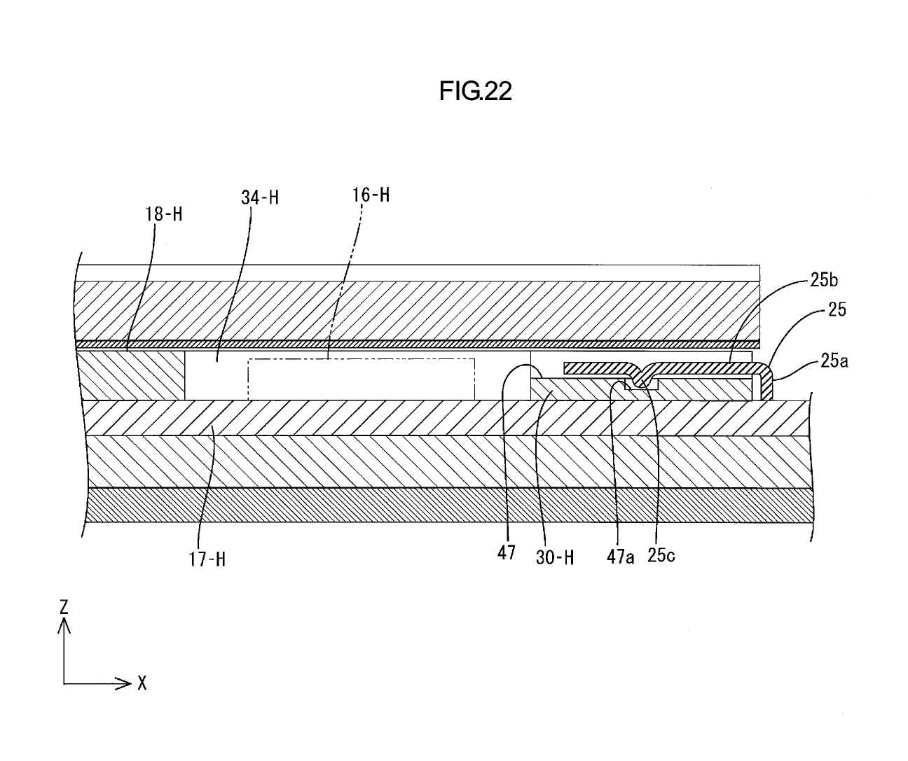

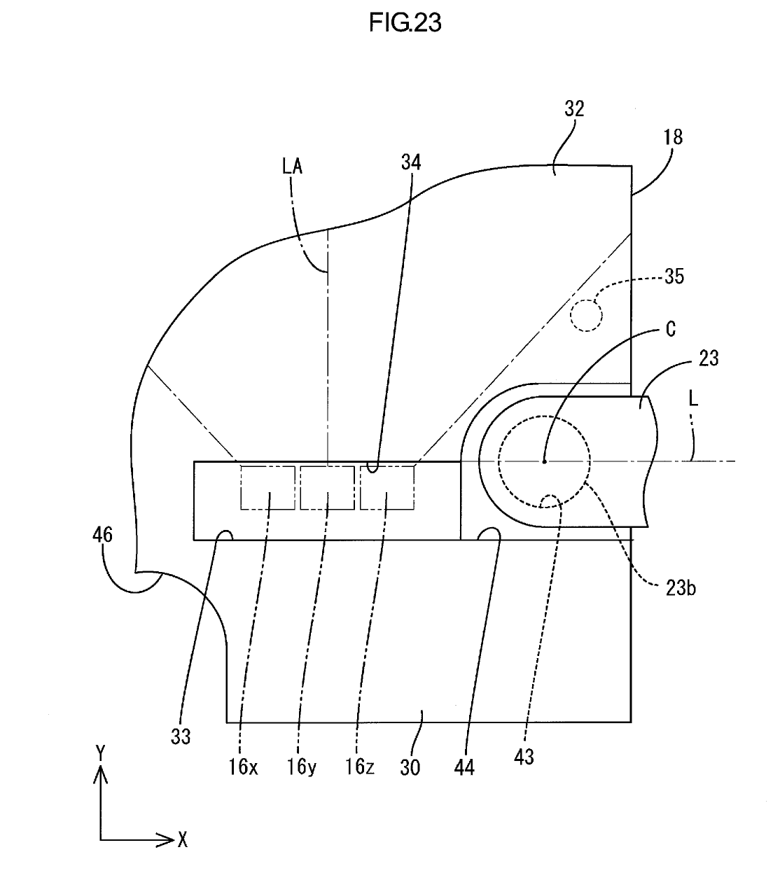

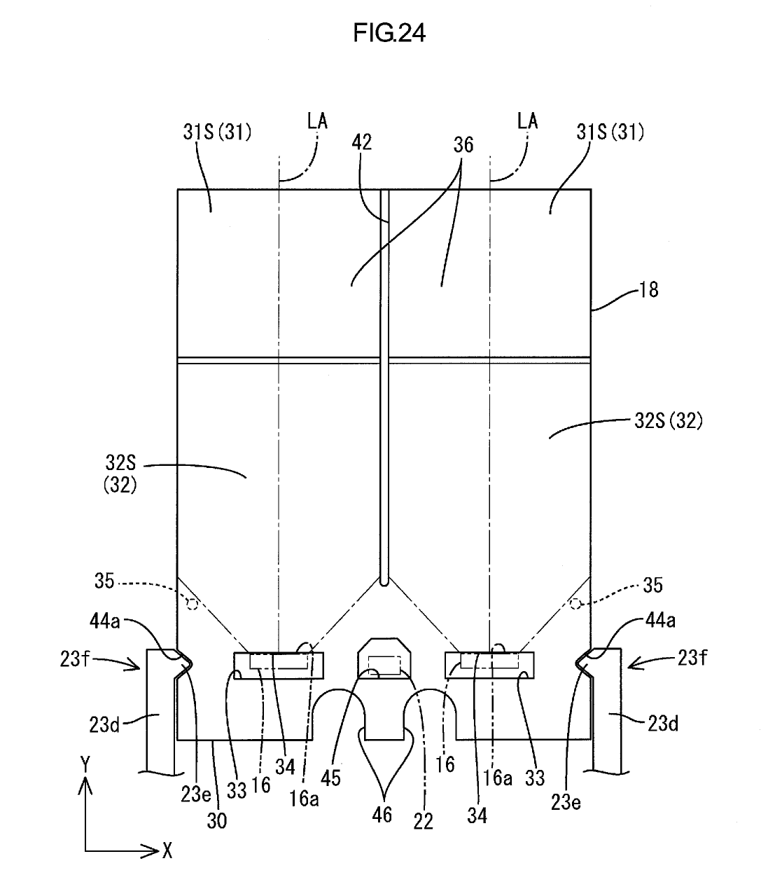

### BRIEF DESCRIPTION OF THE DRAWINGS

[FIG. 1] is an exploded perspective view illustrating a general construction of a television receiver according to the first embodiment of the present invention;

[FIG. 2] is an exploded perspective view illustrating a general construction of a liquid crystal panel and a backlight unit;

[FIG. 3] is a plan view of the backlight unit;

[FIG. 4] is a cross-sectional view of a liquid crystal display device along the long side thereof;

[FIG. 5] is a magnified cross-sectional view of an end portion of the liquid crystal display device in FIG. 4;

[FIG. 6] is a magnified cross-sectional view of the light guide plate illustrated in FIG. 5;

[FIG. 7] is a magnified cross-sectional view of a lower end portion of the liquid crystal display device in FIG. 3 along the short side thereof;

[FIG. 8] is a magnified cross-sectional view of an upper end portion of the liquid crystal display device in FIG. 3 along the short side thereof;

[FIG. 9] is a magnified cross-sectional view of a middle portion of the liquid crystal display device along the short side thereof;

[FIG. 10] is a magnified cross-sectional view of the light guide plate in FIG. 9;

[FIG. 11] is a plan view illustrating a layout of the light guide plates;

[FIG. 12] is a plan view of the light guide plate;

[FIG. 13] is a bottom view of the light guide plate;

[FIG. 14] is a magnified plan view of the light guide plate in adjacent to the LED in FIG. 12;

[FIG. 15] is a magnified plan view of the light guide plate in adjacent to the LED according to a second embodiment of the present invention;

[FIG. 16] is a magnified plan view of the light guide plate in adjacent to the LED according to a third embodiment of the present invention;

[FIG. 17] is a magnified plan view of the light guide plate in adjacent to the LED according to a fourth embodiment of the present invention;

[FIG. 18] is a magnified plan view of the light guide plate in adjacent to the LED according to a fifth embodiment of the present invention;

[FIG. 19] is a magnified plan view of the light guide plate in adjacent to the LED according to a sixth embodiment of the present invention;

[FIG. 20] is a magnified plan view of the light guide plate in adjacent to the LED according to a seventh embodiment of the present invention;

[FIG. 21] is a magnified plan view of the light guide plate in adjacent to the LED according to an eighth embodiment of the present invention;

[FIG. 22] is a magnified plan view of the light guide plate in adjacent to the stopper according to a ninth embodiment of the present invention;

[FIG. 23] is a magnified plan view of the light guide plate in adjacent to the LED according to another embodiment of the present invention; and

[FIG. 24] is a plan view of a light guide plate according to another embodiment.

### BEST MODE FOR CARRYING OUT THE INVENTION

### First Embodiment

The first embodiment of the present invention will be explained with reference to FIGS. 1 to 14. In this embodiment, a liquid crystal display device 10 will be explained. X-axes, Y-axes and Z-axes in some figures correspond to each other so as to indicate the respective directions. In FIGS. 4 to 10, the upper side and the lower side correspond to the front-surface side and the rear-surface side, respectively.

As illustrated in FIG. 1, the television receiver TV includes the liquid crystal display device 10 (a display device), cabinets Ca and Cb, a power source P, and a tuner T. The cabinets Ca and Cb sandwich the liquid crystal display device 10 therebetween. The liquid crystal display device 10 is housed in the cabinets Ca and Cb. The liquid crystal display device 10 is held by a stand S in a vertical position in which a display surface 11a is set along a substantially vertical direction (the Y-axis direction). The liquid crystal display device 10 has a landscape rectangular overall shape. As illustrated in FIG. 2, the liquid crystal display device 10 includes a liquid crystal panel 11, which is a display panel, and a backlight unit 12 (an example of a lighting device), which is an external light source. The liquid crystal panel 11 and the backlight unit 12 are held together by a frame-shaped bezel 13 as illustrated in FIG. 2.

“The display surface 11a is set along the vertical direction” is not limited to a condition that the display surface 11a is set parallel to the vertical direction. The display surface 11a may be set along a direction closer to the vertical direction than the horizontal direction. For example, the display surface 11a may be 0° to 45° slanted to the vertical direction, preferably 0° to 30° slanted.

Next, the liquid crystal panel 11 and the backlight unit 12 included in the liquid crystal display device 10 will be explained. The liquid crystal panel (a display panel) 11 has a rectangular plan view and includes a pair of transparent glass substrates bonded together with a predetermined gap therebetween and liquid crystals sealed between the substrates. On one of the glass substrates, switching components (e.g., TFTs), pixel electrodes and an alignment film are arranged. The switching components are connected to gate lines and the source lines that are perpendicular to each other. The pixel electrodes are connected to the switching components. On the other glass substrate, color filters including R (red) G (green) B (blue) color sections in predetermined arrangement, a counter electrode and an alignment film are arranged. Polarizing plates are arranged on outer surfaces of the glass substrates, respectively (see FIG. 5).

Next, the backlight unit 12 will be explained in detail. As illustrated in FIG. 4, the backlight unit 12 includes a chassis 14, an optical member 15, LEDs 16 (light emitting diodes), LED boards 17 and light guide plates 18. The chassis 14 has a box-like overall shape and an opening on the front side (the liquid crystal panel 11 side, the light output side). The optical member 15 is arranged so as to cover the opening. The LEDs 16 are light sources arranged inside the chassis 14. The LEDs 16 are mounted on the LED boards 17. Rays of light emitted from the LEDs 16 are directed to the optical member 15 by the light guide plates 18. The backlight unit 12 further includes a support member 19, a holddown member 20 and heat sinks 21. The support member 19 holds diffusers 15a and 15b included in the optical member 15 from the rear side. The holddown member 20 holds down the diffusers 15a and 15b from the front side. The heat sinks 21 are provided for dissipation of heat generated while the LEDs 16 emit light.

The backlight unit 12 includes a number of unit light emitters arranged in series. Each unit light emitter includes the light guide plate 18 and the LEDs 16 arranged in series. The LEDs 16 are disposed in side-edge areas of each light guide plate 18. A number of the unit light emitters (twenty of them in FIG. 3) are arranged in series along an arrangement direction (an Y-axis direction) in which the LEDs 16 and the light guide plates 18 are arranged in series, that is, in a tandem layout (see FIGS. 7 to 9). Furthermore, the backlight unit 12 includes a number of the unit light emitters (forty of them in FIG. 3) arranged parallel to each other in a direction substantially perpendicular to the tandem arrangement direction (the Y-axis direction) and along the display surface 11a (the X-axis direction). Namely, a number of the unit light emitters are arranged in a plane (i.e., in a two-dimensional parallel layout) along the display surface 11a (the X-Y plane) (see FIG. 3).

Next, components of the backlight unit 12 will be explained in detail. The chassis 14 is made of metal and has a shallow-box-like overall shape (or a shallow-bowl-like overall shape) with the opening on the front-surface side as illustrated in FIG. 4. The chassis 14 includes a bottom plate 14a, side plates 14b and support plates 14c. The bottom plate 14a has a rectangular shape similar to the liquid crystal panel 11. The side plates 14b rise from the respective edges of the bottom plate 14a. The support plates 14c project outward from the respective end edges of the side plates 14b. The long-side direction and the short-side direction of the chassis 14 correspond to the horizontal direction (the X-axis direction) and the vertical direction (the Y-axis direction), respectively. The support plates 14c of the chassis 14 are configured such that the support member 19 and the holddown member 20 are placed thereon, respectively, from the front-surface side. Each support plate 14c has mounting holes 14d that are through holes for holding the bezel 13, the support member 19 and the holddown member 20 together with screws and formed at predetermined positions. One of the mounting holes 14d is illustrated in FIG. 8. An outer edge portion of each support plate 14c on the long side is folded so as to be parallel to the corresponding side plate 14b (see FIG. 4). The bottom plate 14a has insertion holes 14e that are through holes for inserting clips 23 therein (see FIGS. 5 and 6). The light guide plates 18 are mounted to the chassis with the clips 23. The bottom plate 14a also has mounting holes (not shown). The mounting holes are through holes for mounting the LED boards 17 with screws and formed at predetermined positions.

As illustrated in FIG. 4, the optical member 15 is arranged between the liquid crystal panel 11 and the light guide plates 18. It includes the diffusers 15a and 15b arranged on the light guide plate 18 side, and an optical sheet 15c arranged on the liquid crystal panel 11 side. Each of the diffusers 15a and 15b includes a transparent resin base material with a predefined thickness and a large number of diffusing particles scattered in the base material. The diffusers 15a and 15b have functions of diffusing light that passes therethrough. The diffusers 15a and 15b having the same thickness are placed on top of each other. The optical sheet 15c is a thin sheet having a smaller thickness than that of the diffusers 15a and 15b. The optical sheet 15c includes three sheets placed on top of each other, more specifically, a diffusing sheet, a lens sheet and a reflection-type polarizing sheet arranged in this order from the diffuser 15a (15b) side (i.e., from the rear-surface side).

The support member 19 is arranged on outer edge portions of the chassis 14 so as to support almost entire outer edge portions of the diffusers 15a and 15b. As illustrated in FIG. 3, the support member 19 includes a pair of short-side support parts 19A and two different long-side support parts 19B and 19C. The short-side support parts 19A are arranged so as to extend along the respective short sides of the chassis 14. The long-side support parts 19B and 19C are arranged so as to extend along the respective long sides of the chassis 14. The parts of the support member 19 are configured differently according to mounting locations. The symbols 19A to 19C are used for referring to the parts of the support member 19 independently. To refer to the support member 19 as a whole, the numeral 19 without the letters is used.

As illustrated in FIGS. 4 and 5, the short-side support parts 19A have substantially same configurations. Each of them has a substantially L-shape cross section so as to extend along a surface of the support plate 14c and an inner surface of the side plate 14b. A part of each short-side support part 19A parallel to the support plate 14c receives the diffuser 15b in an inner area and a short-side holddown part 20A in an outer area. The short-side holddown part 20A will be explained later. The short-side support parts 19A cover substantially entire lengths of the support plates 14c and the side plates 14b on the short sides.

The long-side support parts 19B and 19C are configured differently. Specifically, the first long-side support part 19B is arranged on the lower side in FIG. 3 (the lower side in the vertical direction) of the chassis 14. As illustrated in FIG. 7, it is arranged so as to extend along the inner surface of the support plate 14c and a surface of the adjacent light guide plate 18 located on the front-surface side (a surface opposite from the LED board 17 side). The first long-side support part 19B has a function of pressing the adjacent light guide plate 18 from the front-surface side. The first long-side support part 19B receives the diffuser 15a that is located on the front-surface side in the inner-edge area, and the first long-side holddown part 20B in the outer-edge area. The first long-side holddown part 20B will be explained later. The inner-edge area of the first long-side support part 19B has a stepped portion 19Ba formed so as to correspond to the shape of the outer edge area of the diffuser 15a that is located on the front-surface side. Adjacent to the stepped portion 19Ba, recesses 19Bb for receiving protrusions 20Bc of the first long-side holddown part 20B are formed in the first long-side support part 19B on the outer side with respect to the stepped portions 19Ba. The first long-side holding part 19B covers substantially entire lengths of the support plate 14c on the long side and non-luminous portions of the adjacent light guide plates 18 (a board mounting portion 30 and a light guide portion 32). The width of the first long-side support part 19B is larger than those of the other support parts 19A and 19C by an area that covers the non-luminous portion.

The second long-side support part 19C is arranged on the upper side of the chassis 14 in FIG. 3 (the upper side in the vertical direction). As illustrated in FIG. 8, the second long-side support part 19C has a crank-like cross section. It is arranged along the inner surfaces of the support plate 14c, the side plate 14b and the bottom plate 14a. A diffuser support protrusion 19Ca is formed in an area of the long-side support part 19C parallel to the support plate 14c so as to protrude on the front-surface side. The diffuser support protrusion 19Ca has an arch-shaped cross section. It is brought into contact with the diffuser 15b on the rear-surface side from the rear-surface side. A light guide plate support protrusion 19Cb is formed in an area of the second long-side support part 19C parallel to the bottom plate 14a so as to protrude on the front-surface side. The light guide plate support protrusion 19Cb has an arch-shaped cross section. It is brought into contact with the adjacent light guide plate 18 from the rear-surface side. The second long-side support part 19C has functions of receiving the diffusers 15a and 15b (i.e., support functions) and light guide plate 18. An area of the second long-side holding part 19C parallel to the support plate 14c and inside with respect to the diffuser support protrusion 19Ca is brought into contact with the end portion of the light guide plate 18 from the rear-surface side. The light guide plate 18 is supported at two points: at the end portion with the support protrusion 19Ca and at the base portion with the light guide support protrusion 19Cb. The second long-side support part 19C covers substantially entire areas of the support plate 14c and the side plate 14b on the long side. A projecting portion 19Cc rises from the outer edge of the second long-side holding part 19C so as to face the end surfaces of the diffusers 15a and 15b.

As illustrated in FIG. 3, the holddown member 20 is arranged on outer edge areas of the chassis 14. A width of the holddown member 20 is smaller than a dimension of the corresponding short sides of the chassis 14 and the diffusers 15a and 15b. Therefore, the holddown member 20 presses parts of the outer edge portion of the diffusers 15a. The holddown member 20 includes short-side holddown parts 20A arranged on the respective short-edge area of the chassis 14 and a plurality of long-side holddown parts 20B and 20C arranged on each long-edge area of the chassis 14. The parts of the holddown member 20 are configured differently according to mounting locations. The symbols 20A to 20C are used for referring to the parts of the holddown member 20 independently. To refer to the holddown member 20 as a whole, the numeral 20 without the letters is used.

The short-side holddown parts 20A are arranged around central portions of the respective short-edge areas of the chassis 14. They are placed on the outer-edge portions of the short-side support parts 19A and fixed with screws. As illustrated in FIGS. 4 and 5, each short-side holddown part 20A has a holding tab 20Aa that projects inward from a body that is screwed. The diffuser 15a is pressed by edge areas of the holding tabs 20Aa from the front-surface side. The liquid crystal panel 11 is placed on the holding tabs from the front-surface side and held between the bezel 13 and the holding tabs 20Aa. Cushion materials 20Ab for the liquid crystal panel 11 are arranged on surfaces of the holding tabs 20Aa.

The long-side holddown parts 20B and 20C are configured differently. The first long-side holddown parts 20B are arranged on the lower side of the chassis 14 in FIG. 3 (the lower side in the vertical direction). As illustrated in FIG. 3, three first long-side holddown parts 20B are arranged at substantially equal intervals. One of them is arranged around the middle of the long-side area of the chassis 14 on the lower side in FIG. 3 and the other two are arranged on either side of the one arranged in the middle. They are placed on the outer edge area of the first long-side support part 19B and screwed. As illustrated in FIG. 7, each first long-side holding part 20B has a holding tab 20Ba on the inner side similar to the short-side holding parts 20A. A surface of the holding tab 20Ba on the rear-surface side presses the diffuser 15a. Surfaces on the front-surface side receive the liquid crystal display panel 11 via cushion materials 20Bb. The first long-side holddown parts 20B has widths larger than those of the other holddown parts 20A and 20C so as to correspond to the first long-side support parts 19B. Protrusions 20Bc for positioning the first long-side holddown parts 20B to the first long-side support parts 19B are formed on the surfaces of the first long-side holddown parts 20B on the rear-surface side.

The second long-side holddown parts 20C are arranged on the upper side of the chassis 14 in FIG. 3 (the upper side in the vertical direction). As illustrated in FIG. 3, two second long-side holddown parts 20C are arranged in a long-edge area of the chassis 14 on the upper side in FIG. 3. The two second long-side holddown parts 20C are arranged farther from a middle portion of the long-edge area in the left and right directions. They are directly placed on the support plate 14c of the chassis 14 and screwed. As illustrated in FIG. 8, each second long-side holddown part 20C has a holding tab 20Ca on the inner side, similar to the short-side holddown parts 20A and the first long-side holing parts 20B. Surfaces of the holding tabs 20Ca on the rear-surface side press the diffuser 15a and the surfaces on the front-surface side receive the liquid crystal panel 11 via cushion materials 20Cb. Other cushion materials 20Cc are provided between the holding tabs 20Ca of the second long-side holddown parts 20C and the bezel 13.

The heat sinks 21 are made of synthetic resin or metal having high thermal conductivity and formed in a sheet-like shape. As illustrated in FIGS. 5 and 7, the heat sinks 21 are arranged inside and outside the chassis 14, respectively. The heat sink 21 inside the chassis 14 is placed between the bottom plate 14a of the chassis 14 and the LED boards 17. It has cutouts for the components in some areas. The heat sink 21 outside the chassis 14 is attached to the rear surface of the bottom plate 14a of the chassis 14.

As illustrated in FIG. 10, the LEDs 16 are surface-mounted to the LED boards 17, that is, the LEDs 16 are surface-mount LEDs. Each LED 16 has a block-like overall shape that is long in the horizontal direction. The LEDs 16 are side emitting LEDs. A side surface of each LED 16 that stands upright from a mounting surface is a light emitting surface 16a. The mounting surface is placed against the LED board 17 (i.e., the bottom surface that is in contact with the LED board 17). A light axis LA of light emitted from the LED 16 is substantially parallel to the display surface 11a of the liquid crystal display panel 11 (the light exit surface 36 of the light guide plate 18) (see FIGS. 7 and 10). Specifically, the light axis LA of the light emitted from the LED 16 matches the short-side direction (the Y-axis direction) of the chassis 14, that is, the vertical direction. The light travels toward the upper side in the vertical direction (a travel direction of the outgoing light from the light exit surface 16a) (see FIGS. 3 and 7). The light emitted from the LED 16 three-dimensionally radiates around the light axis LA in a specified angle range. The directivity thereof is higher than cold cathode tubes. Namely, angle distributions of the LED 16 shows a tendency that the emission intensity of the LED 16 is significantly high along the light axis LA and sharply decreases as the angle to the light axis LA increases. The longitudinal direction of the LED 16 matches the long-side direction of the chassis 14 (the X-axis direction).

The LED 16 includes a plurality of LED chips 16c mounted on a board 16b that is arranged on an opposite side from the light emitting surface 16a (the rear-surface side). The LED chips 16c are light emitting components. The LED 16 is housed in the housing 16d and an inner space of the housing 16d is closed with a resin member 16e. The LED 16 includes three different kinds of the LED chips 16c with different main emission wavelengths. Specifically, each LED chip 16c emits a single color of light of red (R), green (G) or blue (B). The LED chips 16c are arranged parallel to each other along the longitudinal direction of the LED 16. The housing 16d is formed in a drum-like shape that is long in the horizontal direction and in white that provides highlight reflectivity. The rear surface of the board 16b is soldered to a land on the LED board 17.

Each LED board 17 is made of synthetic resin and the surfaces thereof (including a surface facing the light guide plate 18) are in white that provides high light reflectivity. As illustrated in FIG. 3, the LED board 17 is formed in a plate-like shape having a rectangular plan view. The LED board 17 has a long dimension smaller than the short dimension of the bottom plate 14a and thus it can partially cover the bottom plate 14a of the chassis 14. The LED boards 17 are in a plane arrangement in a grid pattern on the surface of the bottom plate 14a of the chassis 14. In FIG. 3, five along the long-side direction of the chassis 14 by five along the short-side direction and a total of 25 LED boards 17 are arranged parallel to each other. Wiring patterns that are metal films are formed on each LED board 17 and the LEDs 16 are mounted in predetermined locations on the LED board 17. The LED boards 17 are connected to an external control board, which is not illustrated in the figures. The control board is configured to feed currents for turning on the LEDs 16 and to perform driving control of the LEDs 16. A number of LEDs 16 are arranged in a planar grid pattern on each LED board 17. The arrangement pitch of the LEDs 16 corresponds to the arrangement pitch of the light guide plates 18, which will be explained later. Specifically, eight along the long-side direction of the LED board 17 by four along the short-side direction thereof and a total of 32 LEDs 16 are arranged parallel to each other on the LED board 17. Photo sensors 22 are also mounted on the respective LED boards 17. Light emitting conditions of the LEDs 16 are determined by the photo sensors 22 and thus feedback control can be performed on the LEDs 16 (see FIGS. 4 and 11). The surface of the LED board 17 on which the LEDs 16 and the photo sensors 22 are mounted is a plate surface that is parallel to the light exit surface 36 of the light guide plate 18. Each LED board 17 has mounting holes 17a for receiving the clips 23 for mounting the light guide plates 18 (see FIG. 6). It also has positioning holes 17b for positioning the light guide plates 18 (see FIG. 10). The mounting holes 17a and the positioning holes 17b are formed in locations corresponding to mounting locations of the light guide plates 18.

Each light guide plate 18 is made of substantially transparent (i.e., having high light transmission capability) synthetic resin (e.g. polycarbonate), a reflective index of which is significantly higher than that of air. As illustrated in FIGS. 7 to 9, the light guide plate 18 draws the rays of light emitted from the LED 16 in the vertical direction (the Y-axis direction), and the rays of light travel through the light guide plate 18 to be directed toward the optical member 15 (in the Z direction). As illustrated in FIG. 12, the light guide plate 18 has a plate-like shape having a rectangular overall plan view. The long-side direction of the light guide plate 18 is parallel to the light axis LA of the LED 16 (the light emitting direction) and the short-side direction of the chassis 14 (the Y-axis direction or the vertical direction). The short-side direction is parallel to the long-side direction of the chassis 14 (the X-axis direction or the horizontal direction). Next, a cross-sectional structure of the light guide plate 18 along the long-side direction will be explained in detail.

As illustrated in FIGS. 7 to 9, the light guide plate 18 has a board mounting portion 30 that is located at one of end portions of the long dimension (on the LED 16 side) and attached to the LED board 17. The other end portion of the long dimension is configured as a light exit portion 31 from which light exits toward the diffusers 15a and 15b. The middle portion between the board mounting portion 30 and the light exit portion 31 is configured as a light guide portion 32. The light guide portion 32 is configured to direct the light to the light exit portion 31 without losing most of the light. Namely, the board mounting portion 30 (LED 16), the light guide portion 32 and the light exit portion 31 are arranged in this order from the LED 16 side along the long-side direction of the light guide plate 18, that is, along the light axis LA of the LED 16 (the light emitting direction, in an arrangement direction in which the LED 16 and the light entrance surface 34 are arranged). The board mounting portion 30 and the light guide portion 32 are non-luminous portions. The light exit portion 31 is a luminous portion. In the following description, a point ahead in a direction from the board mounting portion 30 toward the light exit portion 31 (the light emitting direction of the LED 16 or the direction toward right in FIGS. 7 to 9) is referred to as the front. A point behind in a direction from the light exit portion 31 toward the board mounting portion 30 (the direction toward left in FIGS. 7 to 9) is referred to as the rear.

In front of the board mounting portion 30, an LED holding space 33 for receiving the LED 16 therein is formed so as to run through in the Z-axis direction. A surface of one of inner walls of the LED holding space 33, which faces the light emitting surface 16a of the LEC 16 (i.e., the front surface), is a light entrance surface 34 through which light from the LED 16 enters. The light entrance surface 34 is located between the board mounting portion 30 and the light guide portion 32. About entire peripheries of the light guide portion 32 are flat and smooth surfaces. Scattered reflections do not occur at interfaces (with external air layers). Incident angles of light that strikes the interfaces are larger than a critical angle and thus the light is totally reflected at multiple times while traveling through the light guide portion 32 and guided to the light exit portion 31. Therefore, the light is less likely to leak from the light guide portion 32 and reach other light guide plates 18. The LED chips 16c of the LED 16 emits rays of light in respective RGB colors. Three different colors of the rays are mixed as the rays of light travel through the light guide portion 32 and turn into white. The white light is guided to the light exit portion 31. Since the rays of light are sufficiently diffused in the X-axis direction and the Y-axis direction while traveling through the light guide portion 32, the uniform in-plane brightness distribution can be achieved on the light exit surface 36. Furthermore, positioning protrusion 35 protrudes toward the rear-surface side. It is located in an area of the light guide portion 32 close to the board mounting portion 30 (close to a rear-end area). The light guide plate 18 is positioned with respect to the LED board 17 in the X-axis direction and the Y-axis direction when the protrusion 35 is inserted in the positioning hole 17b of the LED board 17.

A surface of the light exit portion 31 which faces toward the front-surface side is about an entire area of the surface opposite the diffuser 15b is a light exit surface 36. The light exit surface 36 is a substantially flat and smooth surface. It is substantially parallel to the plate surfaces of the diffusers 15a and 15b (or the display surface 11a of the liquid crystal display panel 11) and substantially perpendicular to the light entrance surface 34. The surface of the light exit portion 31 on the rear-surface side (the surface opposite from the light exit surface 36 or the surface facing the LED board 17) is processed so as to form microscopic asperities thereon. The surface with microscopic asperities is a scattering surface 37 that scatters light at the interface. The light that travels through the light guide plate 18 is scattered by the interface of the scattering surface 37. Namely, light rays strike the light exit surface 36 at the incident angles smaller than the critical angle (light rays that break the total reflection) and exit through the light exit surface 36. The scattering surface 37 has a plurality of lines of perforations 37a that extend straight along the short-side direction of the light guide plate 18 and parallel to each other. The arrangement pitch (the arrangement interval) of the perforations 37a is larger on the rear-end side of the light exit portion 31 than on the front-end side and gradually decreases (FIG. 13). Namely, the density of the perforations 37a of the scattering surface 37 is low on the rear-end side and that is high on the front side. The closer to the LED 16 the lower the density becomes, and the farther from the LED 16 the higher the density becomes, that is, the perforations 37a formed in a gradational arrangement. With this configuration, brightness in the area of the light exit portion 31 closer to the LED 16 is less likely to differ from brightness in the area of the light exit portion 31 father from the LED 16. As a result, the uniform in-plane brightness distribution can be achieved on the light exit surface 36. The scattering surface 37 is provided in the about entire area of the light exit portion 31. The entire area substantially overlaps the light exit surface 36 in the plan view.

A reflection sheet 24 is placed on surfaces of each light exit portion 31 and each light guide portion 32 (including the scattering surface 37) on the rear-surface side. Light reflects off the reflection sheet 24 to be directed into the light guide plate 18. Each reflection sheet 24 is made of synthetic resin and the surface thereof is white that provides high light reflectivity. The reflection sheet 24 is disposed so as to cover about entire areas of the light exit portion 31 and the light guide portion 32 in the plan view (FIG. 13). With the reflection sheet 24, the light that travels through the light guide plate 18 does not leak to the rear-surface side and the light that is scattered at the scattering surface 37 is effectively directed toward the light exit surface 36. The reflection sheet 24 is attached to the light guide plate 18 with transparent adhesives at points in side edge areas that are less likely to interfere with light that travels through the light guide plate 18. The reflection sheet 24 has holes through which the positioning protrusions 35 are passed. The side-edge surfaces and the front-end surface (distal-end surface) of each light exit portion 31 are flat and smooth surfaces similar to those of the light guide portion 32. Therefore, light is less likely to leak.

As illustrated in FIG. 10, the light guide plate 18 has flat surfaces 38 and 41 on the front-surface side (the surface opposite the diffusers 15a and 15b, including the light exit surface 36) and on the rear-surface side (the surface opposite the LED board 17), respectively. The flat surfaces 38 and 41 are substantially parallel to the X-Y plane (or the display surface 11a). The light guide plate 18 also has sloped surfaces 39 and 40. Specifically, the surface of the board mounting portion 30 on the rear-surface side is a mounting surface that is placed on the LED board 17. To make the mounting condition stable, the flat surface 38 (the surface parallel to the main board surface of the LED board 17) is provided. The surfaces of the light guide portion 32 and the light exit portion 31 on the rear-surface side form a continuous sloped surface 39. The board mounting portion 30 of the light guide plate 18 is in contact with the LED board 17 and fixed. The light guide portion 32 and the light exit portion 31 are separated from the LED board 17, that is, they are not in contact with the LED board 17. The light guide plate 18 is held in a cantilever manner with the board mounting portion 30 on the rear side as an anchoring point (or a supporting point) and a front end as a free end.

The surfaces of entire parts of the board mounting portion 30 and the light guide portion 32 and a part of the light exit portion 31 close to the light guide portion 32 on the front-surface side form the continuous sloped surface 40. The sloped surface 40 is sloped at about the same angle and parallel with respect to the sloped surface 39 on the rear-surface side. Namely, the thickness of the light guide plate 18 is substantially constant in the entire light guide portion 32 and a part of the light exit portion 31 close to the light guide portion 32 (close to the LEE 16). The surface of the light exit portion 31 on the front side (away from the LED 16) on the front-surface side is the flat surface 41. Namely, the light exit surface 36 includes the flat surface 41 and the sloped surface 40. Most part of the light exit surface 36 on the front side is the flat surface 41 and a part thereof on the light guide portion 32 side is the sloped surface 40. The thickness of the board mounting portion 30 decreases toward the rear end (as further away from the light guide portion 32), that is, the board mounting portion 30 has a tapered shape. Apart of the light exit portion 31 adjacent to the light guide portion 32 has the sloped surface 40 on the front-surface side and thus the thickness thereof is constant. A part of the light exit portion 31 located more to the front than the above part has the flat surface 41 on the front-surface side. Therefore, the thickness gradually decreases toward the front end (as further away from the light guide portion 32), that is, the light exit portion 31 has a tapered shape. A long dimension (a dimension measuring in the Y-axis direction) of the flat surface 41 on the front-surface side is smaller than that of the flat surface 38 on the rear-surface side. Therefore, the front-end area of the light exit portion 31 is smaller in thickness than the rear-end area of the board mounting portion 30. Moreover, a surface area of the front-end area (distal-end area) of the light exit portion 31 is smaller than that of the rear-end area of the board mounting portion 30. All peripheral surfaces of each light guide plate 18 (including side surfaces and a front surface) are vertically straight surfaces along the Z-axis direction.

As illustrated in FIG. 12, each light guide plate 18 having the above cross sectional structure has a pair of the LED holding spaces 33 for holding the LEDs 16. The light guide plate 18 is configured to receive rays of light from two different LEDs 16 and guide them to the diffusers 15a and 15b in optically independent conditions. The light guide plate 18 will be explained in detail together with a planar arrangement of the components of the light guide plate 18.

The light guide plate 18 has a symmetric shape with a line that passes through the middle of the short side (in the X-axis direction) as a line of symmetry. The LED holding spaces 33 of the board mounting portion 30 are arranged symmetrically a predetermined distance away from the middle of the short side (in the X-axis direction) of the light guide plate 18. Each LED holding space 33 has a landscape rectangular shape in plan view and a size slightly larger than an overall size of the LED 16. The height (the dimension measuring in the Z-axis direction) and the width (the dimension measuring in the X-axis direction) are slightly larger than those of the LED 16. The surface area of the light entrance surface 34 is significantly larger than the light exit surface 16a. Therefore, the rays of light emitted radially from the LED 16 enter the light guide plate 18 without any loss.

At the middle of a short dimension of the light guide plate 18, a slit 42 is formed so as to divide the light guide portion 32 and the light exit portion 31 into right and left. The slit 42 runs through the light guide plate 18 in the thickness direction (the Z-axis direction) and toward the front along the Y-axis direction with a constant width. Edge surfaces of the light guide plate 18, which face the slit 42, form side-edge surfaces of the divided light guide portion 32S and the divided light exit portion 31S. Each side-edge surface includes a flat surface that is substantially straight along the Z-axis direction. The rays of light passing through the light guide plate 18 totally reflect off an interface between the light guide plate 18 and the air layer in the slit 42. Therefore, the rays of light do not travel or mix together between the divided light guide portions 32S that faces each other via the slit 42 or between the divided light exit portions 31S that faces each other via the slit 42. The divided light guide portions 32S and the divided light exit portions 31A are optically independent from each other. The rear end of the slit 42 is slightly more to the front than the positioning protrusion 35 and more to the rear than a lighting area of each LED 16 in the X-axis direction (the area within an angular range with the light axis LA of the LED 16 as the center and indicated by alternate long and short dash lines in FIG. 12). With this configuration, the rays of light emitted from the LED 16 do not directly enter the adjacent divided light guide portion 32S that is not a target to be lit. The positioning protrusions 35 are symmetrically located on the outer end areas of the divided light guide portions 32S (the end portions away from the slit 42) more to the rear than the lighting areas of the respective LEDs 16 with respect to the X-axis direction. Therefore, the positioning protrusions 35 are less likely to be obstacles in optical paths. The slit 42 does not run to the board mounting portion 30. Therefore, the divided light guide portions 32S connect to each other and continue into the board mounting portion 30. This provides mechanical stability in mounting conditions. The light guide plate 18 includes two unit light guide plates (corresponding to the divided light guide portion 32S and the divided light exit portion 31S). The unit light guide plates are optically independent from each other and provided each for each LED 16. The unit light guide plates are connected to each other together with the board mounting portion 30. This simplifies mounting of the light guide plate 18 to the LED board 17. The reflection sheet 24 is placed over the slit 42 (FIG. 13).

Insertion holes 43 are formed in the side-edge areas of the board mounting portion 30 (in the areas more to the outsides than the LED holding space 33). The clip mounting holes 43 are through holes provided for mounting the light guide plate 18 to the LED board 17. The insertion holes 43 are arranged to sandwich collectively the two LED holding spaces 33 and the two LEDs 16 held therein located in a middle portion. The insertion hole 43 is arranged on either side in the X-axis direction (in the direction parallel to the light exit surface 36 and perpendicular to the arrangement direction in which the LED and the light entrance surface 34 are arranged). The insertion holes 43 are arranged on substantially a same level in the front-rear direction.

As illustrated in FIG. 6, each clip 23 includes a mounting plate 23a, an insertion post 23b and a pair of stoppers 23c. The mounting plate 23a is parallel to the board mounting portion 30. The insertion post 23b projects on the LED board 17 side from the mounting plate 23a in the thickness direction (the Z-axis direction) of the board mounting portion 30. The stoppers 23c project from an end of the insertion post 23b so as to return toward the mounting plate 23a. The insertion post 23b of the clip 23 is inserted in the insertion hole 43 of the board mounting portion 30 and the mounting hole 17a of the LED board 17. The stoppers 23c of the clip 23 are held to the edge portions around the mounting hole 17a from the rear side (the opposite side from the mounting plate 23a. As a result, the light guide plate 18 is mounted and fixed to the LED board 17. In the mounted state, the light guide plate 18 is fixed at the two separate points in the short-side direction (the X-axis direction) by the insertion posts 23b inserted in the insertion holes 43. Therefore, the light guide plate 18 is not rotated around the Z-axis (the axis perpendicular to the light exit surface 36). This ensures stable fixing of the light guide plate 18. In the mounted state, the insertion post 23b, the insertion hole 43 and the mounting hole 17a are substantially concentric.

As illustrated in FIGS. 5 and 11, one kind of the clips 23 has a single insertion post 23b projecting from the mounting plate 23a and the other kind has two insertion posts 23b projecting from the mounting plate 23a. The first kind of the clips 23 are inserted in the insertion holes 43 located in the end areas inside the chassis 14. The other kind of the clips 23 are arranged so as to connect two light guide plates 18 that are parallel to each other and thus the two light guide plates 18 are collectively mountable. As illustrated in FIGS. 6 and 12, clip receiving recesses 44 for receiving the mounting plates 23a of the clips 23 are provided around the insertion holes 43. With the clip receiving recesses 44, the mounting plates 23a do not project from the board mounting portions 30 toward the front and thus spaces can be reduced, that is, the thickness of the backlight unit 12 can be reduced.

As illustrated in FIG. 12, each board mounting portion 30 has a photo sensor holding space 45 between the LED holding spaces 33. The photo sensor holding space 45 is a through hole for holding the photo sensor 22 mounted on the LED board 17. A predetermined number of the photo sensors 22 are arranged irregularly, that is, between specific LEDs on the LED boards 17. Namely, some photo sensor holding spaces 45 of the light guide plates 18 in the chassis 14 do not hold the photo sensors 22. Each board mounting portion 30 has cutouts 46 between the photo sensor holding space 45 and each of the LED holding spaces 33 on the board mounting portion 30. The cutouts 46 are located symmetrically. Each cutout 46 runs completely through the board mounting portion 30 similar to the LED holding portion 33 but opens on the rear end. A screw (not shown) for fixing the LED board 17 to the chassis 14 is inserted in the cutout 46. Some of the cutouts are not used for light guide plates 18 in the chassis 14, as some photo sensor holding spaces 45 are not used.

As described above, a large number of the light guide plates 18 are placed in a grid and in a planar arrangement within the area of the bottom plate 14a of the chassis 14. The arrangement of the light guide plates 18 will be explained in detail. First, the arrangement in the tandem-arrangement direction (the Y-axis direction) will be explained. As illustrated in FIG. 9, the light guide plates 18 are mounted such that the light guide portions 32 and the light exit portions 31 are separated from the LED boards 17. The light guide portion 32 and the light exit portion 31 of each light guide plate 18 overlap about entire areas of the board mounting portion 30 (including the clips 23) and the light guide portion 32 of the adjacently located light guide plate 18 on the front side (the upper side in the vertical direction) from the front side. Namely, the board mounting portion 30 and the light guide portion 32 of the light guide plate 18 on the front side overlap the light guide portion 32 and the light exit portion 31 of the light guide plate 18 on the rear side in the plan view. The board mounting portion 30 and the light guide portion 32, which are the non-luminous portion of the light guide plate 18, are covered with the light guide portion 32 and the light exit portion 31 of the adjacent rear light guide plate 18. Namely, the board mounting portion 30 and the light guide portion 32 are not bare on the diffuser 15b side and only the luminous portion, that is, the light exit surface 36 of the light exit portion 31 is bare. With this configuration, the light exit surfaces 36 of the light guide plates 18 are continuously arranged without gaps in the tandem-arrangement direction. About entire rear surfaces of the light guide portion 32 and the light exit portion 31 are covered with the reflection sheet 24. Therefore, even when light is reflected by the light entrance surface 34 and light leak occurs, the leak light does not enter the adjacent light guide plate 18 on the rear side. The clips 23 that fix the board mounting portion 30 to the LED board 17 are covered from the front-surface side with the reflection sheet 24 provided on the adjacent light guide plate 18 on the rear side. Therefore, the clips 23 are not recognized from the front-surface side.

The light guide portion 32 and the light exit portion 31 of the light guide plate 18 on the rear side (the front-surface side) is mechanically supported by the adjacent overlapping light guide plate 18 on the front side (the rear-surface side) from the rear side. The sloped surface 40 of the light guide plate 18 on the front-surface side and the sloped surface 39 on the rear-surface side have substantially same slope angles and are parallel to each other. Therefore, gaps are not created between the overlapping light guide plates 18 and the light guide plates 18 on the rear-surface side support the light guide plates 18 on the front-surface side without rattling. Only front-side parts of the light guide portions 32 of the light guide plates 18 on the rear side cover the board mounting portions 30 of the light guide plates 18 on the front side. The rear-side parts face the LED boards 17.

The arrangement in a direction perpendicular to the tandem-arrangement direction (the X-axis direction) is illustrated in FIGS. 5 and 11. The light guide plates 18 do not overlap each other in the plan view. They are arranged parallel to each other with predetermined gaps therebetween. With the gaps, air layers are provided between the light guide plates 18 adjacent to each other in the X-axis direction. Therefore, the rays of light do not travel or mix between the light guide plates 18 adjacent to each other in the X-axis direction and thus the light guide plates 18 are optically independent from each other. The size of the gaps between the light guide plates 18 is equal to or smaller than that of the slit 42.

As illustrated in FIGS. 3 and 11, a large number of the light guide plates 18 are arranged in the planar arrangement inside the chassis 14. The light exit surface of the backlight unit 12 is formed with a number of the divided light exit portions 31S. As described above, the divided light guide portions 32s and the divided light exit portions 31S of the light guide plates 18 are optically independent from each other. Turning on and off of the LEDs 16 are controlled independently. The outgoing light (amounts of light, emission or non-emission of light) from the divided light exit portion 31S can be controlled independently. The driving of the backlight unit 12 can be controlled using an area active technology that provides control of outgoing light for each area. This significantly improves contrast that is very important for display performance of the liquid crystal display device 10.

As illustrated in FIG. 14, the LED 16 is arranged in the LED holding space 33 with entire peripheries thereof are separated from the inner walls of the LED holding space 33 (including the light entrance surface 34) by gaps in predetermined sizes. The sizes of gaps are not uniform over the entire peripheries of the LED 16. The size of the gap between the light emitting surface 16a and the light entrance surface 34 is quite smaller than the size of the gap between other surfaces. The light emitting surface 16a is located to be close to the light entrance surface 34 of the light guide plate 18 and the gap is extremely small. Accordingly, the rays of light emitted from the light emitting surface 16a of the LED 16 are less likely to be reflected by the light entrance surface 34 and efficiently enter the light entrance surface 34. This improves the light entrance efficiency. The gaps are provided between the LED 16 and the inner peripheries of the LED holding space 33 for compensating for an error related to a mounting position of the light guide plate 18 with respect to the LED board 17. By providing the gaps, the LED 16 is protected from being damaged.

Positions of the light emitting surface 16a of the LED 16, the light entrance surface 34 of the light guide plate 18 and the fixing position (the insertion holes 32 and insertion portions 23b) of the light guide plate 18 by the clips 23 will be explained in detail. As illustrated in FIG. 14, the light emitting surface 16a of the LED 16 and the light entrance surface 34 of the light guide plate 18 are parallel to each other and formed in substantially flat surfaces parallel to the X-axis direction or the light exit surface 36 and parallel to a direction perpendicular to an arrangement direction in which the LED 16 and the light entrance surface 34 are arranged (the Y-axis direction). The insertion holes 43 in which the clips 23 of the light guide plate 18 are inserted are arranged so as to be on the substantially same level as the light entrance surface 34 in the front-rear direction that is the arrangement direction in which the LED 16 and the light entrance surface 34 are arranged (the Y-axis direction).

Specifically, a center C of the insertion hole 43 and the light entrance surface 34 are on substantially the same level in the front-rear direction, and a line L connecting the center C of the insertion hole 43 and the light entrance surface 34 is substantially parallel to the X-axis direction. Since the insertion post 23b of the clip and the insertion hole 43 are substantially concentric, the positional relation of the center C of the insertion post 23b and the light entrance surface 34 in the front-rear direction is similar to the above-mentioned one.

Namely, the insertion post 23b of the clip 23 and the light entrance surface 23 are located on substantially the same level in the front-rear direction. The insertion holes 43 (insertion posts 23b) provided on two end sides of the light guide plate 18 respectively are located on substantially the same level in the front-rear direciton and therefore, the center C of each insertion hole 43 (insertion post 23b) is on the line L. A flat surface 38 formed on a rear surface of the light guide plate 18 is formed around the entire peripheries of the insertion holes 43 (FIG. 13). Accordingly, when the light guide plate 18 is fixed to the LED board 17 by the clips 23, the entire peripheral ends of the insertion holes 43 come in surface-contact with the LED board 17. This improves stable fixing of the light guide plate 18 to the LED board 17. The flat surface 38 is formed on an entire area of the board mounting portion 30 as mentioned before and partially formed on the light guide portion 32.

The light guide plates 18 having the above-mentioned structure are mounted on the LED board 17 in the manufacturing process of the backlight unit 12. The LEDs 16 are mounted on the LED board 17. Specifically, each LED board 17 is attached to the bottom plate 14a of the chassis 14 in a predetermined position (FIG. 3), and then the light guide plate 18 is mounted in a position corresponding to each LED 16 of each LED board 17. In such a case, the light guide plate 18 is mounted in a position corresponding to the LEDs 16 at an upper end position (a front end position) in the vertical direction (the tandem-arrangement direction, Y-axis direction) on the bottom plate 14a of the chassis 14. Then, the light guide plates 18 are sequentially mounted in positions corresponding to the LEDs 16 at a lower side (rear side) in the vertical direction (FIGS. 7 to 9). The light guide plates 18 mounted secondarily and later in the vertical direction partially overlap the adjacent light guide plate 18 at the upper side (the front side) in the vertical direction on the front-surface side. Accordingly, the light guide plates 18 are arranged in the tandem arrangement along the vertical direction with overlapping each other.

Next, the fixing of each light guide plate 18 will be explained in detail. In mounting the light guide plate 18, the light guide plate 18 is placed on the LED board 17 such that the LED holding spaces 33 correspond to the LEDs 16 and the insertion holes 43 correspond to the mounting holes 17a of the LED board 17 respectively. In such a state, the insertion post 23b of each clip 23 is inserted in the corresponding insertion hole 43 and mounting hole 17a from the front-surface side. In the insertion process, the stoppers 23c are temporally deformed elastically to be folded (to be closer to the insertion portion 23b) by the ends of the insertion hole 43 and the mounting hole 17a. When the insertion post 23b is inserted to a regular depth, the stoppers 23c are restored to their original shape and the distal ends of the stoppers 23c are in contact with the ends of the mounting hole 17a in the LED board 17 from rear-surface side (the side opposite from the mounting plate 23a) as illustrated in FIG. 6. Accordingly, the light guide plate 18 is fixed to the LED board 17 with the board mounting portion 30 and the LED board 17 being held between the mounting plate 23a and the stoppers 23c. In this state, an entire area of the mounting plate 23a is received in the clip receiving recess 44 and is not projected to the front-surface side from the board mounting portion 30. As illustrated in FIG. 12, the light guide plate 18 includes a pair of insertion holes 43 in which the clips 23 are inserted and the light guide plate 18 is fixed at the two points. Therefore, the light guide plate 18 is not rotated around the Z-axis. Furthermore, the insertion holes 43 are provided at two sides of the light guide plate 18 so as to hold the LEDs 16 therebetween. Therefore, the light guide plate 18 is fixed stably and the positions of the light entrance surface 34 with respect to the LED 16 in the front-rear direction is stably determined.

After the light guide plates 18 are mounted to the LED board 17 as described before, other components are mounted thereto to complete the assembling of the backlight unit 12 and the liquid crystal display device 10. Power of the liquid crystal display device 10 is turned on to light each LED 16. Generation of heat from each LED 16 increases the temperature in the backlight unit 12. Accordingly, thermal expansion occurs in each light guide plate 18 and it originates from the fixing points of the light guide plate 18 with respect to the LED board 17 by the clips 23, that is the insertion posts 23b (the insertion holes 43) of the clips 23. The fixing points are origins of the occurrence of the thermal expansion. 18 (for example, the front end portion of the light exit portion 31) that is far from the insertion post 23b (the fixing point) of the clip 23 that is an origin of the thermal expansion has a greater expansion amount. The portion of the light guide plate 18 close to the insertion post 23b has a smaller expansion amount. Namely, the expansion amount of the light guide plate 18 due to the thermal expansion is proportional to the distance from the insertion post 23b that is an origin of the thermal expansion.

In the present embodiment, as illustrated in FIG. 14, the center C of the insertion post 23b and the light entrance surface 34 are on substantially the same level in the front-rear direction and the distance between the insertion post 23b that is the origin of the thermal expansion and the light entrance 34 is substantially zero. Therefore, even if the thermal expansion occurs in the light guide plate 18, the relative positions of the light entrance surface 34 with respect to the light emitting surface 16a of the LED 16 are not changed. If the light entrance surface 34 moves frontward relatively to the light emitting surface 16a of the LED 16 due to the occurrence of the thermal expansion of the light guide plate 18, the gap (space, clearance) between the LED 16 and the light entrance surface 34 increases. Accordingly, the rays of light emitted from the LED 16 are likely to be reflected by the light entrance surface 34. This lowers the entrance efficiency of light entering the light entrance surface 34 and the exit efficiency of light exiting from the light exit surface 36 and this may deteriorate brightness of the whole light guide plate 18. In the present embodiment, even if the thermal expansion occurs in the light guide plate 18, the light entrance surface 34 does not move frontward relatively to the light emitting surface 16a of the LED 16. Therefore, the size of the gap between the light emitting surface 16a and the light entrance surface 34 is substantially constant and the entrance efficiency of light entering the light entrance surface 34 and the exit efficiency of light exiting from the light exit surface 36 are substantially constant. This keeps stable improved brightness of the light guide plate 18. In the present embodiment, as illustrated in FIGS. 3 and 11, a number of the light guide plates 18 are arranged two-dimensionally parallel to each other in the chassis 14 and a number of the light exit surfaces 36 of the light guide plates 18 form a light exit surface of the backlight unit 12. Brightness of each light guide plate 18 is stabilized and this unifies the in-plane brightness distribution in the light exit surface of the backlight unit 12. Accordingly, the uneven brightness in the light exit surface of the backlight unit 12 is less likely to be caused.

While the power of the liquid crystal display device 10 is on, all the LEDs 16 are not always on. If the driving of the backlight unit 12 is controlled using an area active technology, emission or non-emission of light from each LED 16 is controlled for each divided area of the display surface 11a based on the image signal input from the liquid crystal panel 11. If the driving of the backlight unit 12 is controlled using a PWM control method, each of the LEDs 16 blinks periodically and the time ratio of the emission period and the non-emission period is changed. In any control methods, the temperature in the backlight unit 12 rises and is lowered according to the emission or non-emission of each LED 16. If the temperature is lowered, the thermal contraction occurs in the light guide plate 18. As mentioned before, the insertion post 23b of the clip 23 that fixes the light guide plate 18 to the LED board 16 is on substantially the same level as the light entrance surface 34 in the front-rear direction. Therefore, even if the thermal expansion occurs in the light guide plate 18, the light entrance surface 34 does not move rearward relatively to the light emitting surface 16a of the LED 16. Therefore, the size of the gap between the light emitting surface 16a and the light entrance surface 34 is constant and the entrance efficiency and the exit efficiency of the light with respect to the light guide plate 18 are constant. This keeps stably improved brightness of the light guide plate 18.

As explained before, the backlight unit 12 of the present embodiment includes the LED 16, the light guide plate 18, the LED board 17 and the clip 23. The light guide plate 18 has the light entrance surface 34 and the light exit surface 36. The light entrance surface 34 is provided to face the LED 16 and rays of light emitted from the LED 16 enter the light entrance surface 34. The light exit surface 36 is provided parallel to an arrangement direction in which the LED 16 and the light entrance surface 34 are arranged and the rays of light exit through the light exit surface 36. The LED 16 and the light guide plate 18 are fixed to the LED board 17. The light guide plate 18 is fixed to the LED board 17 by the clip 23 and the clip 23 is provided in adjacent to the light entrance surface 34 with respect to the arrangement direction in which the LED 16 and the light entrance surface 34 are arranged.

Turning on and off of the LED 16 changes the temperature environment in the backlight unit 12 and this causes thermal expansion or thermal contraction in the light guide plate 18.

In such a case, the thermal expansion or the thermal contraction is originated from the fixing point of the light guide plate 18 to the LED board 17 by the clip 23. The clip 23 is located in adjacent to the light entrance surface 34 with respect to the arrangement direction in which the LED 16 and the light entrance surface 34 are arranged. Therefore, even if thermal expansion or thermal contraction occurs in the light guide plate 18, change in the relative positions of LED 16 and the light entrance surface 34 with respect to the arrangement direction is less likely to occur. Therefore, the entrance efficiency of light emitted from the LED 16 and entering the light guide plate 18 is stabilized and this stabilizes brightness of the light guide plate 18.

Furthermore, the fixing point by the clip 23 (the insertion post 23b and the insertion hole 43) is provided to be on substantially the same level as the light entrance surface 34 in the arrangement direction in which the LED 16 and the light entrance surface 34 are arranged. With this configuration, change in the relative positions of the LED 16 and the light entrance surface 34 in the arrangement direction in which the LED 16 and the light entrance surface 34 are arranged is less likely to occur. This stabilizes the entrance efficiency of light entering the light entrance surface 34. The fixing point by the clip 23 is set in an area ranging from the point at which the center of the insertion post 23b is on substantially the same level as the light entrance surface 34 in the arrangement direction to the point at which the center of the insertion post 23b is on substantially the same level as the light emitting surface 16a of the LED 16 facing the light entrance surface 34.

The fixing points by the clips 23 are provided on the sides of the light guide plate 18 sandwiching the LEDs 16 therebetween in the direction parallel to the light exit surface 36 and crossing the arrangement direction in which the LED 16 and the light entrance surface 34 are arranged. With this configuration, the fixing points by the clips 23 are provided on two sides of the light guide plate 18 sandwiching the LEDs 16 therebetween. This stably fixes the light guide plate 18 and the positions of the light entrance surface 34 relative to the LED 16 with respect to the arrangement direction in which the LED 16 and the light entrance surface 34 are arranged are stably kept.

The two fixing points by the clips 23 are provided on substantially the same level in the arrangement direction in which the LED 16 and the light entrance surface 34 are arranged. With this configuration, the light guide plate 18 is further stably fixed and the positions of the light entrance surface 34 relative to the LED 16 is stable.

A number of the LEDs 16 are arranged parallel to each other and a number of the light guide plates 18 are also arranged parallel to each other. With this configuration, the brightness of each light guide plate 18 is stable and therefore the uneven brightness is less likely to be caused in the backlight unit 12.

The LEDs 16 and the light guide plates 18 are arranged two-dimensionally parallel to each other. With this configuration, the light exit surface 36 of each light guide plate 18 is arranged two-dimensionally parallel to each other, and therefore the uneven brightness is less likely to be caused in the backlight unit 12.

The reflection sheet 24 is provided on a surface of the light guide plate 18 opposite from the light exit surface 36 to reflect rays of light to the light exit surface 36 side. The clip 23 is covered with the reflection sheet 24 provided on the adjacent light guide plate 18. Accordingly, the clip 23 is not recognized from the light exit surface 36 side and the uneven brightness is less likely to be caused in the backlight unit 12.

The insertion holes 43 are provided at the sides of the light entrance surface 34 in a direction parallel to the light exit surface 36 and crossing the arrangement direction in which the LED 16 and the light entrance surface 34 are arranged. The clips 23 are inserted through the insertion holes 43. The insertion holes 43 are formed in the light guide plate 18 and the clips 23 are inserted therethrough. This may make the clips 23 to be optical obstacles in an optical path of the light traveling in the light guide plate 18. However, each of the insertion holes 43 is provided at the side of the light entrance surface 34. This solves the above-mentioned problem and stabilizes the brightness of the light guide plate 18.

The clip 23 is comprised of the mounting plate 23a, the insertion post 23b and the stoppers 23c. The mounting plate 23a is provided on a surface of the light guide plate 18 opposite from the LED board 17 side. The insertion post 23b projects from the mounting plate 23a toward the LED board 17 side and is inserted in the insertion hole 43 and the mounting hole 17a formed in the LED board 17. The stoppers 23c are formed on the insertion post 23b and come in contact with the LED board 17 from a side opposite from the mounting plate 23a side. With this configuration, the insertion post 23b of the clip 23 penetrates through the light guide plate 18 and the LED board 17 and the light guide plate 18 and the LED board 17 are fixed together with being sandwiched between the mounting plate 23a and the stoppers 23c. This achieves stable fixing.

The clip receiving recess 44 is formed on the light guide plate 18 to receive the mounting plate 23a. With this configuration, the mounting plate 23a is received in the clip receiving recess 44 and this reduces the thickness of the backlight unit 12.

The LED board 17 on which the LEDs 16 are mounted is used as a base member to which the LEDs 16 and the light guide plate 18 are fixed. Thus, the light guide plate 18 is fixed by the clips 23 to the LED board 17 on which the LEDs 16 are mounted. This keeps stably the positions of the LED 16 and the light entrance surface 34.

The light guide plate 18 includes the board mounting portion 30 that is mounted to the LED board 17, the light guide portion 32 that guides rays of light entering the light entrance surface 34 and the light exit portion 31 having the light exit surface 36 and from which the rays of light guided from the light guide portion exit to outside. The board mounting portion 30, the light guide portion 32 and the light exit portion 31 are provided continuously along the arrangement direction in which the LED 16 and the light entrance surface 34 are arranged. With this configuration, the light guide plate 18 is formed in an elongated shape along the arrangement direction in which the LED 16 and the light entrance surface 34 are arranged and the expansion amount and the contraction amount due to the thermal expansion and the thermal contraction increase. The present embodiment is preferable for such a light guide plate 18.

The LED 16 that is mounted on the LED board 17 is used as the light source. With this configuration, improved brightness is achieved.

### Second Embodiment

Next, the second embodiment of the present invention will be explained with reference to FIG. 15. In the second embodiment, the position of a clip 23-A relative to a light entrance surface 34-A is different from that in the first embodiment. The same components as the first embodiment will be indicated with the same symbols. The symbols with the letter A are used for referring to the same parts as the first embodiment. The same configuration, functions and effects will not be explained.

As illustrated in FIG. 15, an insertion hole 43 of a light guide plate 18-A and the insertion post 23b-A of the clip 23-A are located on substantially the same level as a light emitting surface 16a-A of the LED 16-A in the front-rear direction (the arrangement direction in which the LED 16-A and the light entrance surface 34-A are arranged). A straight line L-A connecting a center C-A of the insertion hole 43-A and the light emitting surface 16a-A is substantially parallel to the X-axis direction. In other words, the insertion hole 43-A and the insertion post 23b-A are located closer to the rear side (the LED 16-A side) by the gap between the light emitting surface 16a-A and the light entrance surface 34-A from the light entrance surface 34-A. With such an arrangement, if thermal expansion occurs in the light guide plate 18-A, the light entrance surface 34-A moves quite slightly in relative to the light emitting surface 16a-A of the LED 16-A. The entrance efficiency and the exit efficiency of light with respect to the light guide plate 18-A are less likely to be deteriorated.

As explained before, according to the present embodiment, the fixing point by the clip 23-A is set in an area ranging from the point at which the center of the insertion post 23b-A is on substantially the same level as the light entrance surface 34-A in the arrangement direction to the point at which the center of the insertion post 23b-A is on substantially the same level as the light emitting surface 16a-A of the LED 16 facing the light entrance surface 34-A in the arrangement direction in which the LED 16-A and the light entrance surface 34-A are arranged. The clip 23-A is arranged in such an area so that the relative position of the LED 16-A and the light entrance surface 34-A are less likely to be changed with respect to the arrangement direction in which the LED 16-A and the light entrance surface 34-A are arranged.

The fixing point by the clip 23-A, that is the center C-A, is located closer to the LED 16-A side from the light entrance surface 34-A. With this configuration, the clip 23-A is not an optical obstacle in the path of rays of light entering the light entrance surface 34-A. This keeps the brightness of the light guide plate 18-A stably.

### Third Embodiment

Next, the third embodiment of the present invention will be explained with reference to FIG. 16. In the third embodiment, the position of a clip 23-B relative to a light entrance surface 34-B is changed. The same components as the first embodiment will be indicated with the same symbols. The symbols with the letter B are used for referring to the same parts as the first embodiment. The same configuration, functions and effects will not be explained.

As illustrated in FIG. 16, an insertion hole 43-B of a light guide plate 18-B and an insertion post 23b-B of the clip 23-B are located on substantially the same level as a middle portion of an LED 16-B in the front-rear direction (the arrangement direction in which the LED 16-B and the light entrance surface 34-B are arranged). A straight line L-B connecting a center C-B of the insertion hole 43-B and the middle portion of the LED 16-B is substantially parallel to the X-axis direction. With such an arrangement, if thermal expansion occurs in the light guide plate 18-B, the light entrance surface 34-B moves quite slightly in relative to the light emitting surface 16a-B of the LED 16-B. The entrance efficiency and the exit efficiency of light with respect to the light guide plate 18-B are less likely to be deteriorated.

As explained before, according to the present embodiment, the fixing point by the clip 23-B is set in an area ranging from the point at which the center of the insertion post 23b-B is on substantially the same level as the light entrance surface 34-B in the arrangement direction to the point at which the center of the insertion post 23b-B is on substantially the same level as the side end of the LED 16-B opposite from the light entrance surface 34-B side in the arrangement direction in which the LED 16-B and the light entrance surface 34-B are arranged. The clip 23-B is arranged in such an area so that the relative position of the LED 16-B and the light entrance surface 34-B are less likely to be changed with respect to the arrangement direction in which the LED 16-B and the light entrance surface 34-B are arranged.

The fixing point by the clip 23-B, that is the center C-B, is located closer to the LED 16-B side from the light entrance surface 34-B. With this configuration, the clip 23-B is not an optical obstacle in the path of rays of light entering the light entrance surface 34-B. This keeps the brightness of the light guide plate 18-B stably.

### Fourth Embodiment

Next, the fourth embodiment of the present invention will be explained with reference to FIG. 17. In the fourth embodiment, the relative position of the light entrance surface 34-C and a clip 23-c is further changed. The same components as the first embodiment will be indicated with the same symbols. The symbols with the letter C are used for referring to the same parts as the first embodiment. The same configuration, functions and effects will not be explained.

As illustrated in FIG. 17, an insertion hole 43-C of a light guide plate 18-C and an insertion post 23b-C of the clip 23-C are located on substantially the same level as a rear end surface 16f of the LED 16-C in the front-rear direction (the arrangement direction in which the LED 16-C and the light entrance surface 34-C are arranged). A straight line L-C connecting a center C-C of the insertion hole 43-C and the rear end surface 16f of the LED 16-C is substantially parallel to the X-axis direction. With such an arrangement, if thermal expansion occurs in the light guide plate 18-C, the light entrance surface 34-C moves quite slightly in relative to the light emitting surface 16a-C of the LED 16-C. The entrance efficiency and the exit efficiency of light with respect to the light guide plate 18-C are less likely to be deteriorated.

As explained before, according to the present embodiment, the fixing point by the clip 23-C is set in an area ranging from the point at which the center of the insertion post 23b-C is on substantially the same level as the light entrance surface 34-C in the arrangement direction to the point at which the center of the insertion post 23b-C is on substantially the same level as the rear end surface 16f of the LED 16-C that is opposite from the light entrance surface 34-C side in the arrangement direction in which the LED 16-C and the light entrance surface 34-C are arranged. The clip 23-C is arranged in such an area so that the relative position of the LED 16-C and the light entrance surface 34-C are less likely to be changed with respect to the arrangement direction in which the LED 16-C and the light entrance surface 34-C are arranged.

The fixing point by the clip 23-C, that is the center C-C, is located closer to the LED 16-C side from the light entrance surface 34-C. With this configuration, the clip 23-C is not an optical obstacle in the path of rays of light entering the light entrance surface 34-C. This keeps the brightness of the light guide plate 18-C stably.

### Fifth Embodiment

Next, the fifth embodiment of the present invention will be explained with reference to FIG. 18. In the fifth embodiment, a size of a gap between an LED 16-D and a light entrance surface 34-D is altered. The same components as the first and fourth embodiments will be indicated with the same symbols. The symbols with the letter D are used for referring to the same parts as the first embodiment. The same configuration, functions and effects will not be explained.

As illustrated in FIG. 18, the LED 16-d is arranged in substantially the middle portion in the LED holding space of the light guide plate 18-D. A size of a gap between the light entrance surface 34-D that is a front end surface of the LED holding space 33-D and a light emitting surface 16a-D is substantially equal to a size of a gap between the rear end surface of the LED holding space 33-D and a rear end surface 16f-D of the LED 16-D. Therefore, compared to the first to fourth embodiments, the size of the gap provided between the light emitting surface 16a-D of the LED 16-D and the light entrance surface 34-D is relatively greater. The gap having a sufficient size is ensured to surely compensate for an error related to a mounting position of the light guide plate 18-D with respect to the LED board. By providing such a gap, the light guide plate 18-D does not unnecessarily come in contact with the LED 16-D.

### Sixth Embodiment

Next, the sixth embodiment of the present invention will be explained with reference to FIG. 19. In the sixth embodiment, a shape of a light entrance surface 34-E of a light guide plate 18-E is altered. The same components as the first embodiment will be indicated with the same symbols. The symbols with the letter E are used for referring to the same parts as the first embodiment. The same configuration, functions and effects will not be explained.

As illustrated in FIG. 19, the light entrance surface 34-E is formed in a recessed and curved surface in a plan view. Specifically, the light entrance surface 34-E has a cross section of substantially an arched shape taken along an X-Y plane that is a cross section taken along a surface substantially perpendicular to the arrangement direction in which the light emitting surface 16a-E and the light entrance surface 34-E are arranged and parallel to the light exit surface. Unlike the light entrance surface 34-E, the light emitting surface 16a-E of the LED 16-E is substantially a flat surface along the X-axis direction. Therefore, a size of a gap between the light entrance surface 34-E and the light emitting surface 16a-E is maximum at a middle portion in the X-axis direction and reduces as it is close to the ends.

The insertion hole 43-E of the light guide plate 18-E and the insertion post 23b-E of the clip 23-E are located on substantially the same level as a front end of the light entrance surface 34-E having the above-mentioned shape in the front-rear direction. Specifically, a center of each of the insertion hole 43-E and the insertion post 23b-E is located on a tangent TL to the front end of the light entrance surface 34-E that is a tangent TL to the middle portion of the light entrance surface 34-E in the X-axis direction. Thus, the center of each of the insertion hole 43-E and the insertion post 23b-E is located on substantially the same level as the light entrance surface 34-E in the front-rear direction. Therefore, even if thermal expansion or thermal contraction occurs in the light guide plate 18-E, movement of the light entrance surface 34-E relative to the LED 16-E is less likely to occur.

### Seventh Embodiment

Next, the seventh embodiment of the present invention will be explained with reference to FIG. 20. In the seventh embodiment, a shape of a light emitting surface 16a-F of an LED 16-F is altered from the sixth embodiment. The same components as the first and sixth embodiments will be indicated with the same symbols. The symbols with the letter F are used for referring to the same parts as the first and sixth embodiments. The same configuration, functions and effects will not be explained.

As illustrated in FIG. 20, the light emitting surface 16a-F of the LED 16-F is formed in a recessed and curved surface in a plan view so as to follow the light entrance surface 34-F of the light guide plate 18-F. Specifically, the light emitting surface 16a-F of the LED 16-F has a cross section of substantially an arched shape taken along an X-Y plane that is a cross section taken along a surface substantially perpendicular to the arrangement direction in which the light emitting surface 16a-F and the light entrance surface 34-F are arranged and parallel to the light exit surface. The arched cross sectional shapes of the light emitting surface 16a-F and the light entrance surface 23-F are concentric.

Therefore, a size of a gap between the light entrance surface 34-F and the light emitting surface 16a-F is substantially constant over an entire area. A center C-F of each of the insertion hole 43-F and the insertion post 23b-F is located on a tangent TL-F to the front end of the light entrance surface 34-F that is a tangent TL to the middle portion of the light entrance surface 34-F in the X-axis direction and is located on substantially the same level as the light entrance surface 34-F in the front-rear direction.

### Eight Embodiment

Next, the eighth embodiment of the present invention will be explained with reference to FIG. 21. In the eighth embodiment, a structure for holding an LED 16-G of the light guide plate 18-G is altered. The same components as the first embodiment will be indicated with the same symbols. The symbols with the letter G are used for referring to the same parts as the first and sixth embodiments. The same configuration, functions and effects will not be explained.

As illustrated in FIG. 21, the LED holding space 33-G for holding the LED 16-G is formed to penetrate through the light guide plate 18-G in the thickness direction and open to the rear side. Namely, the end surface forming the LED holding space 33-G is formed in a portal shape in a plan view that is a loop having ends. The LED holding space 33-G is open to the rear side and therefore the light entrance surface 34-G is bared to outside on the rear side. A cutout 46-G is provided on a rear side of a photo sensor holding hole 45-G on a board mounting portion 30-G.

### Ninth Embodiment

Next, the ninth embodiment of the present invention will be explained with reference to FIG. 22. In the ninth embodiment, a fixing structure for fixing a light guide plate 18-H is altered. The same components as the first embodiment will be indicated with the same symbols. The symbols with the letter H are used for referring to the same parts as the first embodiment. The same configuration, functions and effects will not be explained.

As illustrated in FIG. 22, in the present embodiment, a stopper 25 is integrally formed with a LED board 17-H as a fixing member for fixing the light guide plate 18-H. The stopper 25 is provided on a side of the LED 16-H on the LED board 17-H so as to be farther from the LED 16-H by a predetermined distance in the X-axis direction (the distance that allows to receive the board mounting portion 30-H of the light guide plate 18-H). The stopper 25 includes a basal portion 25a that extends upward from a surface of the LED board 17-H on a front-surface side and an arm 25b that is bent from the basal portion 25a to the LED 16-H side. The arm 25b is provided in a cantilever manner with the basal end portion (the bent portion formed continuously from the basal portion 25a) as an anchoring point and is elastically deformable in the Z-axis direction. A stopper projection 25c is formed on a portion of the arm 25b between the basal end portion and a free end portion so as to project to the LED board 17-H side. As is not illustrated in the drawing, a pair of the stoppers 25 is arranged on two sides of the LED board 17-H so as to collectively sandwich the two LEDs 16 H.

A recess 47 for receiving the stopper 25 is formed on the board mounting portion 30-H of the light guide plate 18-H. When the stopper 25 is received in the recess 47, the stopper 25 is not projected from the board mounting portion 30-H on the front-surface side. The relative position of the recess 47 and the stopper 25 is similar to the relative position of the clip receiving recess 44 and the mounting plate 23a (FIG. 6) mentioned in the first embodiment and the same explanation thereof will be omitted. A projection receiving recess 47a for receiving the stopper projection 25c of the arm 25b is formed on a surface of the recess 47 that faces the arm 25b of the stopper 25 (on a front surface). When the light guide plate 18-H is mounted to the LED board 17-H, the arm 25b of the stopper 25 is received in the recess 47 and the stopper projection 25c is fit in the stopper receiving recess 47a and the peripheral surfaces thereof are in contact with each other. Accordingly, the light guide plate 18-H is fixed to the LED board 17-H in a predetermined position. In the mounted state, the stopper 25 extends from a side of the light guide plate 18-H in the X-axis direction. The arrangement of the stopper 25 with respect to the light entrance surface 34-H of the light guide plate 18-H or the light emitting surface of the LED 16-H in the front-rear direction is selected from any one of the arrangements described in the first to eight embodiments.

As mentioned above, according to the present embodiment, the fixing member for fixing the light guide plate 18-H is integrally formed with the LED board 17-H and is comprised of the stopper 25 that is received and engaged by the stopper receiving recess 47a formed on the light guide plate 18-H. With this configuration, the stopper 25 that is integrally formed with the LED board 17-H fixes the light guide plate 18-H and this achieves stable fixing. The stopper 25 that is a fixing member is integrally formed with the LED board 17-H. Therefore, compared to the case in which the stopper is formed separately from the LED board, the number of parts, the number of assembling processes and manufacturing cost are reduced.

### Other Embodiments

The present invention is not limited to the above embodiments explained in the above description. The following embodiments may be included in the technical scope of the present invention, for example.

(1) The fixing position of the light guide plate by the fixing member such as the clip in the front-rear direction is not limited to the one described in the first to fourth embodiments but may be altered as necessary. For example, the fixing position may be provided between the light emitting surface of the LED and the light entrance surface and may be provided on the rear side of the rear end surface of the LED. As mentioned before, as the fixing position of the light guide plate by the fixing member such as the clip in the front-rear direction becomes closer to the light entrance surface in the front-rear direction, the relative position of the LED and the light entrance surface is less likely to change due to thermal expansion or thermal contraction of the light guide plate. Therefore, the fixing position of the light guide plate by the fixing member such as the clip in the front-rear direction can be altered as necessary as long as the fixing position is adjacent to the light entrance surface and the change in the relative positions of the LED and the light entrance surface due to thermal expansion or thermal contraction of the light guide plate does not cause adverse optical effect on the light guide plate.

(2) In the above embodiments, a pair of the fixing points of the light guide plate by the fixing member such as the clip is provided. However, the number of the fixing points may be one or three or more. If the number of the fixing points is one, the fixing point is preferable to be provided in a middle portion of the light guide plate in the short-side direction. If the number of the fixing points is three or more, at least two fixing points are preferable to be provided to sandwich the LED. As long as at least one fixing point is provided in adjacent to the light entrance surface, the other fixing points are not necessarily provided in adjacent to the light entrance surface. The arrangement of the fixing points in the front-rear direction can be set freely.

(3) In the above embodiments, a slight gap is provided between the light emitting surface of the LED and the light entrance surface. However, such a gap may not be provided and no clearance is provided therebetween and the light emitting surface and the light entrance surface may be in contact with each other. With this configuration, the entrance efficiency of rays of light entering the light entrance surface is further improved.

(4) In the above embodiments, the light guide plate is fixed to the LED board. However, the light guide plate may be fixed to a bottom plate of a chassis to which the LED board is integrally fixed. In such a case, the bottom plate of the chassis is the base member. The light guide plate is fixed directly to the bottom plate of the chassis that is the base member and the LED is fixed indirectly to the bottom plate of the chassis that is the base member via the LED board.

(5) In the ninth embodiment, the stopper extends from a side of the light guide plate. However, the stopper may extend from a rear side of the light guide plate. In such a case, the basal portion of the stopper and the light entrance surface may be provided along the front-rear direction and the basal portion may not be provided on a side of the light entrance surface.

(6) In the ninth embodiment, the stopper projection is provided on the stopper and the stopper recess is provided on the light guide plate. However, the stopper recess may be provided on the stopper and the stopper projection may be provided on the light guide plate.

(7) In the above embodiments, the clip or the stopper are used as the fixing member. However, an adhesive or double-sided tape may be used as the fixing member. With this configuration, recesses or projections such as the insertion holes or the stopper recesses are not necessary to be formed on the light guide plate. The adverse optical effect is not caused on the light guide plate. Accordingly, the fixing point by the fixing member may be set just in front of the light entrance surface and the fixing points may be freely set.

(8) In the above embodiments, each light guide plate has a single slit and two divided light exit portions and two divided light guide portions (the light entrance surfaces) are provided. However, each light guide plate may have two or more slits and three or more divided light exit portions and three or more divided light guide portions (the light entrance surfaces) may be provided. With such a configuration, a single light guide plate can collectively cover three or more LEDs. This makes assembly of the backlight unit easier. In such a case also, the light guide plate may be preferably fixed by the fixing members such as the clips at two fixing positions that collectively hold the LEDs.

(9) In the above embodiments, each light guide plate has the slit that divides the light exit portion and the light guide portion so that the single light plate collectively covers a number of LEDs. However, each light guide plate may not have the slit and each light guide plate may include a single LED (i.e., a single light entrance surface). With this configuration, light from the adjacent LED that is not an object to be covered by a specific light guide plate is less likely to enter the specific light guide plate. In such a case also, the light guide plate may be preferably fixed by the fixing members such as the clips at two fixing positions that collectively hold the LEDs.

(10) In the above embodiments, each light guide plate has a rectangular shape in a plan view. However, each light guide plate may have a square shape in a plan view. The lengths, the widths, the thicknesses and the outer surface shapes of each board mounting portion, each light guide portion and each light exit portion can be altered as necessary.

(11) In the above embodiments, each LED emits light upward in the vertical direction. However, the light emitting direction of each LED can be altered as necessary. Namely, each LED can be mounted to the LED board in a suitable position. Specifically, each LED can be mounted to the LED board so as to emit light downward in the vertical direction, or such that the light emitting direction (the light axis) aligned with the horizontal direction. The LEDs with different light emitting directions may be included.

(12) In the above embodiments, the light guide plates are arranged so as to overlap each other in a plan view. However, the light guide plates may be arranged so as not to overlap each other in a plan view.

(13) In the above embodiments, the LEDs and the light guide plates (unit light emission members) are arranged parallel to each other two-dimensionally. However, they may be arranged parallel to each other one-dimensionally. Specifically, the LED and the light guide plates may be arranged parallel to each other only in the vertical direction or the LED and the light guide plates may be arranged parallel to each other only in the horizontal direction.

(14) In the above embodiments, each LED includes three different LED chips configured to emit respective colors of RGB. However, LEDs each including a single LED chip configured to emit a single color of blue or violet and each configured to emit white light using fluorescent material may be used.

(15) In the above embodiments, each LED includes three different LED chips configured to emit respective colors of RGB. However, LEDs each including three different LED chips configured to emit respective colors of cyan (C), magenta (M) and yellow (Y) may be used.

(16) In the above embodiments, the LEDs are used as point light sources. However, point light sources other than LEDs can be used.

(17) In the above embodiments, the point light sources are used as the light sources. However, linear light sources such as cold cathode tubes and hot cathode tubes may be used. A combination of point light sources such as the LED, cold cathode tubes and hot cathode tubes may be used.

(18) Planar light sources such as organic ELs may be used other than the above embodiments and the embodiments (16) and (17).

(19) The optical member may be configured differently from the above embodiments. Specifically, the number of diffusers or the number and the kind of the optical sheets can be altered as necessary. Furthermore, a plurality of optical sheets in the same kind may be used.

(20) In the above embodiments, the liquid crystal panel and the chassis are held in the vertical position with the short-side direction thereof aligned with the vertical direction. However, the liquid crystal panel and the chassis may be held in the vertical position with the long-side direction thereof aligned with the vertical direction.

(21) In the above embodiments, TFTs are used as switching components of the liquid crystal display device. However, the technology described the above can be applied to liquid crystal display devices including switching components other than TFTs (e.g., thin film diode (TFD)). Moreover, the technology can be applied to not only color liquid crystal display devices but also black-and-white liquid crystal display devices.

(22) In the above embodiments, the liquid crystal display device including the liquid crystal panel as a display component is used in the above embodiment. The technology can be applied to display devices including other types of display components.

(23) In the above embodiments, the television receiver including the tuner is used. However, the technology can be applied to a display device without a tuner.

(24) In the above embodiments, a number of the light guide plates are used. However, a member that guides rays of light emitted from each LED is comprised of a single member.

(25) In the above embodiments, one single LED is received in the LED receiving recess. However, as illustrated in FIG. 23, the LED receiving recess receives a number of LEDs 16x, 16y, 16z. A number of LED chips may be provided in a unit.

(26) In the above embodiments, the clip that fixes the light guide plate to the LED board from an upper-surface side of the light guide plate is used as the fixing member. However, as illustrated in FIG. 24, a member that fixes the light guide plate 18 at sides in a lateral direction of the light guide plate 18 may used as the fixing member. In such a case, the fixing member 23f includes an elastic member 23d having a projection 23e. The projection 23e is fitted to the recess 44a of the light guide plate 18 by using the elasticity of the elastic member 23d.

1. A lighting device comprising:
a light source;
a light guide member including a light entrance surface and a light exit surface, the light entrance surface being provided to face the light source and that light emitted from the light source enters and the light exit surface being provided parallel to an arrangement direction in which the light source and the light entrance surface are arranged and through which the light exits;
a base member to which the light source and the light guide member are fixed; and
a fixing member configured to fix the light guide member to the base member and provided in adjacent to the light entrance surface in the arrangement direction in which the light source and the light entrance surface are arranged.

2. The lighting device according to claim 1, wherein the fixing member is provided in an area ranging from the light entrance surface to an end of the light source that is opposite from a light entrance surface side with respect to the arrangement direction.

3. The lighting device according to claim 2, wherein the fixing member is provided in an area ranging from the light entrance surface to a light emitting surface of the light source that faces the light entrance surface with respect to the arrangement direction.

4. The lighting device according to claim 3, wherein the fixing member is provided on a same level as the light entrance surface in the arrangement direction.

5. The lighting device according to claim 1, wherein the fixing member is provided on a light source side with respect to the light entrance surface.

6. The lighting device according to claim 1, wherein the fixing member includes a pair of fixing members and each of the fixing members is provided on a side of the light source so as to sandwich the light source with respect to a direction parallel to the light exit surface and crossing the arrangement direction.

7. The lighting device according to claim 6, wherein the pair of fixing members are on substantially a same level in the arrangement direction.

8. The lighting device according to claim 1, wherein the light source includes a number of light sources and the light guide member includes a number of light guide members, and the light sources are arranged parallel to each other and the light guide members are arranged parallel to each other.

9. The lighting device according to claim 8, wherein the light sources and the light guide members are arranged two-dimensionally parallel to each other.

10. The lighting device according to claim 8, further comprising a reflection member provided on a surface of the light guide member that is opposite from the light exit surface and configured to reflect light to the light exit surface side, wherein the fixing member is covered with the reflection member of adjacent light guide member.

11. The lighting device according to claim 1, wherein the fixing member is provided to be inserted through an insertion hole that is formed in the light guide member and provided on a side of the light entrance surface in a direction parallel to the light exit surface and crossing the arrangement direction.

12. The lighting device according to claim 11, wherein the fixing member includes:
a mounting portion provided on a side of the light guide member opposite from the base member side;
an insertion portion provided to be projected from the mounting portion to the base member side and configured to be inserted in the insertion hole and a mounting hole formed in the base member; and
a stopper provided on the insertion portion and configured to be fitted to the base member from a side opposite from the mounting portion side.

13. The lighting device according to claim 12, wherein the light guide member includes a receiving recess that receives the mounting portion.

14. The lighting device according to claim 1, wherein the fixing member is provided integrally with the base member and is a stopper that is configured to be fitted to a fitting portion formed on the light guide member.

15. The lighting device according to claim 1, wherein the base member is a circuit board on which the light source is mounted.

16. The lighting device according to claim 15, wherein the light guide member includes:
a board mounting portion that is mounted to the circuit board;
a light guide portion that guides light entering the light entrance surface; and
a light exit portion that has the light exit surface and through which light from the light guide portion exits, wherein the board mounting portion, the light guide portion and the light exit portion are continuously provided in the arrangement direction.

17. The lighting device according to claim 15, wherein the light source is a light emitting diode that is mounted on the circuit board.

18. A display device comprising:
the lighting device according to claim 1; and
a display panel configured to provide display using light from the lighting device.

19. The display device according to claim 18, wherein the display panel is a liquid crystal panel including liquid crystals sealed between a pair of substrates.

20. A television receiver comprising the display device according to claim 18.
